(19) United States
(12) Patent Application Publication
(10) Pub. No.: US 2006/0138944 A1
(43) Pub. Date: Jun. 29, 2006

(54) Addressable and printable emissive display

(75) Inventors: William Johnstone Ray, Okemos, MI (US); Mark David Lowenthal, East Lansing, MI (US); Timothy Charles Claypole, Swansea (GB)

Correspondence Address: GAMBURD LAW GROUP LLC, 566 WEST ADAMS, SUITE 350, CHICAGO, IL, 60661, US

(73) Assignee: Quantum Paper

(21) Appl. No.: 11/023,064

(22) Filed: Dec. 27, 2004

(51) Int. Cl. H05B 33/00

(52) U.S. Cl. 313/506

(57) ABSTRACT

The various embodiments of the invention provide an addressable emissive display comprising a plurality of layers, including a first substrate layer, wherein each succeeding layer is formed by printing or coating the layer over preceding layers. Exemplary substrates include paper, plastic, rubber, fabric, glass, ceramic, or any other insulator or semiconductor. In an exemplary embodiment, the display includes a first conductive layer attached to the substrate and forming a first plurality of conductors; various dielectric layers; an emissive layer; a second, transmissive conductive layer forming a second plurality of conductors; a third conductive layer included in the second plurality of conductors and having a comparatively lower impedance; and optional color and masking layers. Pixels are defined by the corresponding display regions between the first and second plurality of conductors. Various embodiments are addressable, have a substantially flat form factor with a thickness of 1-3 mm, and are also scalable virtually limitlessly, from the size of a mobile telephone display to that of a billboard.

### FIELD OF THE INVENTION

The present invention in general is related to electronic display technology and, in particular, is related to an emissive display technology capable of being printed or coated on a wide variety of substrates, and which may further be electronically addressable in various forms for real-time display of information.

### BACKGROUND OF THE INVENTION

Display technologies have included television cathode ray tubes, plasma displays, and various forms of flat panel displays. Typical television cathode ray tube displays utilize an emissive coating, typically referred to as a “phosphor” on an interior, front surface, which is energized from a scanning electron beam, generally in a pattern referred to as a raster scan. Such television displays have a large, very deep form factor, making them unsuitable for many purposes.

Other displays frequently used for television, such as plasma displays, while having a comparatively flat form factor, involve a complex array of plasma cells containing a selected gas or gas mixture. Using row and column addressing to select a picture element (or pixel), as these cells are energized, the contained gas is ionized and emits ultraviolet radiation, causing the pixel or subpixel containing a corresponding color phosphor to emit light. Involving myriad gas-containing and phosphor-lined cells, these displays are complicated and expensive to manufacture, also making them unsuitable for many purposes.

Other newer display technologies, such as active and passive matrix liquid crystal displays (“LCDs”), also include such pixel addressability, namely, the capability of individually addressing a selected picture element. Such displays include a complex array of layers of transistors, LCDs, vertically polarizing filters, and horizontally polarizing filters. In such displays, there is often a light source which is always powered on and emitting light, with the light actually transmitted controlled by addressing particular LCDs within an LCD matrix. Such addressing, however, is accomplished through additional layers of transistors, which control the on and off state of a given LCD.

Currently, creation of such displays requires semiconductor fabrication techniques to create the controlling transistors, among other things. A wide variety of technologies are involved to fabricate the liquid crystal layer and various polarizing layers. LCD displays also are complicated and expensive to manufacture and, again, unsuitable for many purposes.

Using simpler fabrication techniques, electroluminescent lamp (EL) technology has provided for printing or coating emissive material, such as phosphors, in conjunction with conductive layers, to form signage and other fixed displays. For these displays, a given area is energized, and that entire area becomes emissive, providing the display lighting. Such prior art EL displays, however, do not provide any form of pixel addressability and, as a consequence, are incapable of correspondingly displaying dynamically changing information. For example, such prior art EL displays cannot display an unlimited amount of information, such as any web page which may be downloaded over the internet, or any page of a book or magazine, also for example.

Such prior art displays which are incapable of pixel addressability include those discussed in Murasko U.S. Pat. No. 6,203,391, issued Mar. 20, 2001, entitled “Electroluminescent Sign”; Murasko U.S. Pat. No. 6,424,088, issued Jul. 23, 2002, entitled “Electroluminescent Sign”; Murasko U.S. Pat. No. 6,811,895, issued Nov. 2, 2004, entitled “Illuminated Display System and Process”; and Barnardo et al. U.S. Pat. No. 6,777,884, issued Aug. 17, 2004, entitled “Electroluminescent Devices”. In these displays, electrodes and emissive material are printed or coated on a substrate, in a “sandwich” of layers, in various designs or patterns. Once energized, the design or pattern is illuminated in its entirety, forming the display of fixed, unchanging information, such as for illuminated signage.

As a consequence, a need remains for an emissive display which provides for pixel addressability, for the display of dynamically changing information. Such a display further should be capable of fabrication using printing or coating technologies, rather than using complicated and expensive semiconductor fabrication techniques. Such a display should be capable of fabrication in a spectrum of sizes, from a size comparable to a mobile telephone display, to that of a billboard display (or larger). Such a display should also be robust and capable of operating under a wide variety of conditions.

### SUMMARY OF THE INVENTION

The various embodiments of the invention provide an addressable emissive display comprising a plurality of layers over a substrate, with each succeeding layer formed by printing or coating the layer over preceding layers. The first, substrate layer may be paper, plastic, rubber, fabric, glass, ceramic, or any other insulator or semiconductor, for example. In an exemplary embodiment, the display includes a first conductive layer attached to the substrate and forming a first plurality of conductors, followed by a first dielectric layer, an emissive layer, a second dielectric layer, a second, transmissive conductive layer forming a second plurality of conductors; a third conductive layer included in the second plurality of conductors and having a comparatively lower impedance; and optional color and masking layers. Pixels are defined by the corresponding display regions between the first and second plurality of conductors. Various embodiments are pixel addressable, for example, by selecting a first conductor of the first plurality of conductors and a second conductor of the second plurality of conductors.

As a light emitting display, the various embodiments of the invention have highly unusual properties. First, they may be formed by any of a plurality of conventional and comparatively inexpensive printing or coating processes, rather than through the highly involved and expensive semiconductor fabrication techniques, such as those utilized to make LCD displays, plasma displays, or ACTFEL displays. The invention may be embodied using comparatively inexpensive materials, such as paper and phosphors, substantially reducing production costs and expenses. The ease of fabrication using printing processes, combined with reduced materials costs, may revolutionize display technologies and the industries which depend upon such displays, from computers to mobile telephones to financial exchanges.

Yet additional advantages of the invention are that the various embodiments are scalable, virtually limitlessly, while having a substantially flat form factor. For example, the various embodiments may be scaled up to wallpaper, billboard or larger size, or down to cellular telephone or wristwatch display size. At the same time, the various embodiments have a substantially flat form factor, with the total display thickness in the range of 50-55 microns, plus the additional thickness of the selected substrate, resulting in a display thickness on the order of 1-3 millimeters. For example, using 3 mill paper (approximately 75 microns thick), the thickness of the resulting display is on the order of 130 microns, providing one of, if not the, thinnest addressable display to date.

In addition, the various embodiments provide a wide range of selectable resolutions and are highly and unusually robust.

In a first exemplary embodiment of the invention, an emissive display comprises: a substrate; a first plurality of conductors coupled to the substrate; a first dielectric layer coupled to the first plurality of conductors; an emissive layer coupled to the first dielectric layer; and a second plurality of conductors coupled to the emissive layer, wherein the second plurality of conductors are, at least partially, adapted to transmit visible light. Such an emissive display is adapted to emit visible light from the emissive layer through the second plurality of conductors when a first conductor of the first plurality of conductors and a second conductor of the second plurality of conductors are energized.

In the first exemplary embodiment, the first plurality of conductors may be substantially parallel in a first direction, and the second plurality of conductors may be substantially parallel in a second direction, with the second direction being different than the first direction. For example, the first plurality of conductors and the second plurality of conductors may be disposed to each other in substantially perpendicular directions, such that a region substantially between a first conductor of the first plurality of conductors and a second conductor of the second plurality of conductors defines a picture element (pixel) or subpixel of the emissive display. The pixel or subpixel of the emissive display is selectively addressable by selecting the first conductor of the first plurality of conductors and selecting the second conductor of the second plurality of conductors. Such selection may be an application of a voltage, wherein the addressed pixel or subpixel of the emissive display emits light upon application of the voltage.

In the first exemplary embodiment of the invention, a third plurality of conductors may be coupled correspondingly to the second plurality of conductors, where the third plurality of conductors have an impedance comparatively lower than the second plurality of conductors. For example, each conductor of the third plurality of conductors may comprise at least two redundant conductive paths and be formed from a conductive ink.

Additional layers of the first exemplary embodiment of the invention may include a color layer coupled to the second conductive layer, with the color layer having a plurality of red, green and blue pixels or subpixels; a masking layer coupled to the color layer, the masking layer comprising a plurality of opaque areas adapted to mask selected pixels or subpixels of the plurality of red, green and blue pixels or subpixels; a calcium carbonate coating layer; and other sealing layers.

In a second exemplary embodiment of the invention, an emissive display comprises: a substrate; a first conductive layer coupled to the substrate; a first dielectric layer coupled to the first conductive layer; an emissive layer coupled to the first dielectric layer; a second dielectric layer coupled to the emissive layer; a second, transmissive conductive layer coupled to the second dielectric layer; and a third conductive layer coupled to the second transmissive conductive layer, the third conductive layer having a comparatively lower impedance than the second transmissive conductive layer.

In a third exemplary embodiment of the invention, an emissive display comprises: a substrate; a first conductive layer coupled to the substrate, the first conductive layer comprising a first plurality of electrodes and a second plurality of electrodes, the second plurality of electrodes electrically insulated from the first plurality of electrodes; a first dielectric layer coupled to the first conductive layer; an emissive layer coupled to the first dielectric layer; a second dielectric layer coupled to the emissive layer; and a second, transmissive conductive layer coupled to the second dielectric layer. The second transmissive conductive layer may be further coupled to the second plurality of electrodes, such as through an electrical via connection or by abutment. The emissive display of the third exemplary embodiment is adapted to emit visible light from the emissive layer when the first plurality of electrodes, second plurality of electrodes, and the second, transmissive conductive layer are energized.

In a fourth exemplary embodiment of the invention, an emissive display comprises: a substrate; a first plurality of conductors coupled to the substrate; a first dielectric layer coupled to the first plurality of conductors, the first dielectric layer having a plurality of reflective interfaces; an emissive layer coupled to the first dielectric layer and the plurality of reflective interfaces; and a second plurality of conductors coupled to the emissive layer, wherein the second plurality of conductors are, at least partially, adapted to transmit visible light. In this exemplary embodiment, the plurality of reflective interfaces are metal, metal flakes, such as those formed by printing a metal flake ink, or may be comprised of a compound or material which has a refractive index different from refractive indices of the first dielectric layer and the emissive layer. When a region substantially between a first conductor of the first plurality of conductors and a second conductor of the second plurality of conductors defines a picture element (pixel) or subpixel of the emissive display, in this embodiment, at least one reflective interface of the plurality of reflective interfaces is within each pixel or most pixels.

In another exemplary embodiment of the invention, a method of fabricating an emissive display comprises: using a conductive ink, printing a first conductive layer, in a first selected pattern, on a substrate; printing a first dielectric layer over the first conductive layer; printing an emissive layer over the first dielectric layer; printing a second dielectric layer over the emissive layer; printing a second, transmissive conductive layer, in a second selected pattern, over the second dielectric layer; and using a conductive ink, printing a third conductive layer over the second transmissive conductive layer, wherein the third conductive layer has a comparatively lower impedance than the second transmissive conductive layer. The step of printing the third conductive layer may also include printing a conductive ink in a third selected pattern having at least two redundant conductive paths, and the step of printing the first dielectric layer may also include printing a plurality of reflective interfaces. The exemplary method embodiment may also comprise printing a color layer over the second dielectric layer, a second conductive layer or a third conductive layer, the color layer comprising a plurality of red, green and blue pixels or subpixels; and printing a masking layer in a fourth selected pattern over the color layer, the masking layer comprising a plurality of opaque areas adapted to mask selected pixels or subpixels of the plurality of red, green and blue pixels or subpixels.

In the exemplary method embodiment, the first selected pattern defines a first plurality of conductors disposed in a first direction, and the second selected pattern defines a second plurality of conductors disposed in a second direction, with the second direction different from the first direction.

In the exemplary method embodiment of the invention, the step of printing the first conductive layer may further comprise printing a first plurality of conductors, and the step of printing the second conductive layer may further comprise printing a second plurality of conductors disposed to the first plurality of conductors in a substantially perpendicular direction to create a region substantially between a first conductor of the first plurality of conductors and a second conductor of the second plurality of conductors which defines a picture element (pixel) or subpixel of the emissive display.

Numerous other advantages and features of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various diagrams, in which:

FIG. 1 (or FIG. 1) is a perspective view of a first exemplary apparatus embodiment 100 in accordance with the teachings of the present invention.

FIG. 2 (or FIG. 2) is a cross-sectional view of the first exemplary apparatus embodiment in accordance with the teachings of the present invention.

FIG. 3 (or FIG. 3) is a perspective view of a second exemplary apparatus embodiment in accordance with the teachings of the present invention.

FIG. 4 (or FIG. 4) is a cross-sectional view of the second exemplary apparatus embodiment in accordance with the teachings of the present invention.

FIG. 5 (or FIG. 5) is a cross-sectional view of the second exemplary apparatus embodiment in accordance with the teachings of the present invention.

FIG. 6 (or FIG. 6) is a perspective view of an emissive region (or pixel) of the second exemplary embodiment in accordance with the teachings of the present invention.

FIG. 7 (or FIG. 7) is a perspective view of a third exemplary apparatus embodiment in accordance with the teachings of the present invention.

FIG. 8 (or FIG. 8) is a cross-sectional view of the third exemplary apparatus embodiment in accordance with the teachings of the present invention.

FIG. 9 (or FIG. 9) is a perspective view of an emissive region of the third exemplary embodiment in accordance with the teachings of the present invention.

FIG. 10 (or FIG. 10) is a top view of a third conductor disposed within a second, transmissive conductor of the various exemplary embodiments in accordance with the teachings of the present invention.

FIG. 11 (or FIG. 11) is a perspective view of a fourth exemplary apparatus embodiment in accordance with the teachings of the present invention.

FIG. 12 (or FIG. 12) is a cross-sectional view of the fourth exemplary apparatus embodiment in accordance with the teachings of the present invention.

FIG. 13 (or FIG. 13) is a perspective view of a fifth exemplary apparatus embodiment in accordance with the teachings of the present invention.

FIG. 14 (or FIG. 14) is a cross-sectional view of the fifth exemplary apparatus embodiment in accordance with the teachings of the present invention.

FIG. 15 (or FIG. 15) is a cross-sectional view of the fifth exemplary apparatus embodiment in accordance with the teachings of the present invention.

FIG. 16 (or FIG. 16) is a block diagram of an exemplary system embodiment in accordance with the teachings of the present invention.

FIG. 17 (or FIG. 17) is a flow chart of an exemplary method embodiment in accordance with the teachings of the present invention.

### DETAILED DESCRIPTION OF THE EXEMPLARY EMBODIMENTS

While the present invention is susceptible of embodiment in many different forms, there are shown in the drawings and will be described herein in detail specific embodiments thereof, with the understanding that the present disclosure is to be considered as an exemplification of the principles of the invention and is not intended to limit the invention to the specific embodiments illustrated. In this respect, before explaining at least one embodiment consistent with the present invention in detail, it is to be understood that the invention is not limited in its application to the details of construction and to the arrangements of components set forth above and below, illustrated in the drawings, or as described in the examples. Methods and apparatuses consistent with the present invention are capable of other embodiments and of being practiced and carried out in various ways. Also, it is to be understood that the phraseology and terminology employed herein, as well as the abstract included below, are for the purposes of description and should not be regarded as limiting.

As mentioned above, the various embodiments of the present invention provide addressable emissive display. The various embodiments of the invention may be formed by any of a plurality of printing or coating processes. The invention may be embodied using comparatively inexpensive materials, such as paper and phosphors, substantially reducing production costs and expenses. The various embodiments are scalable, virtually limitlessly, while having a substantially flat form factor. In addition, the various embodiments provide a wide range of selectable resolutions and are highly and unusually robust.

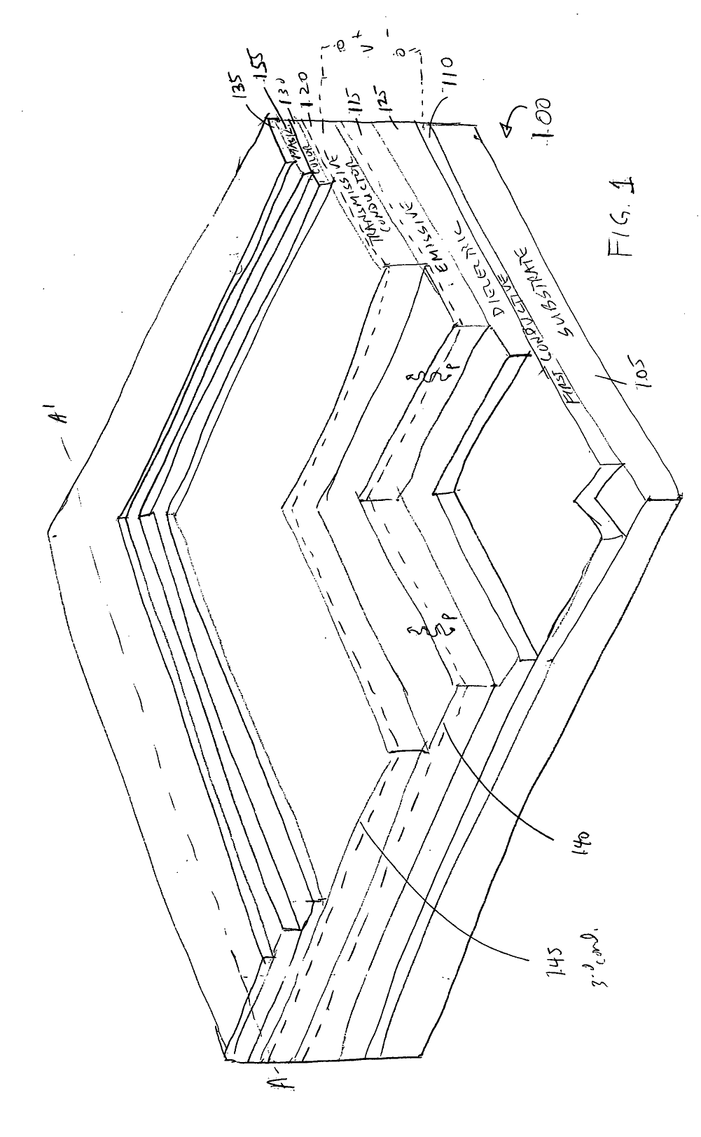

Referring now to the drawings, FIGS. 1-17 illustrate various exemplary embodiments of the present invention. It should be noted that the various FIGS. 1-16 provide highly magnified views of representative portions or sections of the various exemplary apparatus and system embodiments, and are not to scale, for ease of reference. It should also be noted that implementations of the exemplary embodiments are generally quite flat and thin, having a thickness (depth) on the order of several sheets of fine paper, with any selected width and length, such as poster size and billboard size, to smaller scales, such as the size of computer display screens and mobile telephone display screens.

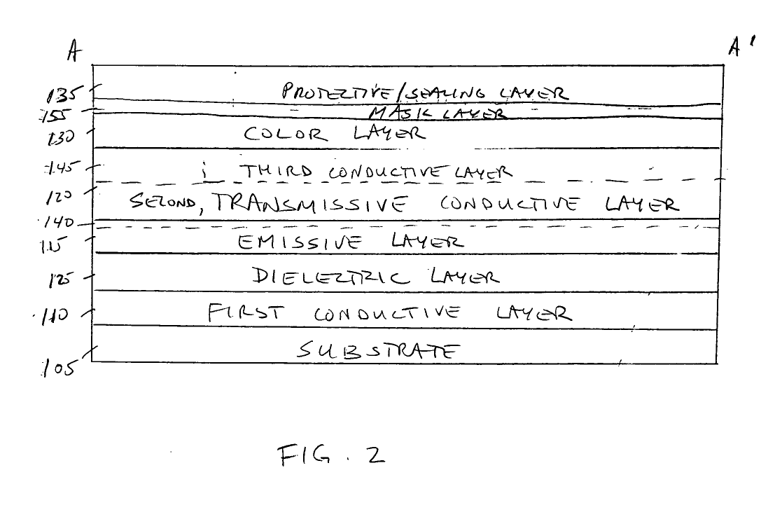

FIG. 1 (or FIG. 1) is a perspective view of a first exemplary apparatus embodiment 100 in accordance with the teachings of the present invention. FIG. 2 (or FIG. 2) is a cross-sectional view of the first exemplary apparatus embodiment 100 in accordance with the teachings of the present invention, from the plane A-A′ illustrated in FIG. 1. Apparatus 100 comprises a plurality of layers, with each layer adjacent the next as illustrated, including a substrate layer 105, a first conductive layer 110, an emissive (visible light emitting) layer 115, and a second, transmissive conductive layer 120. Depending on the selected embodiment, the apparatus 100 also generally includes one or more of the following layers: a first dielectric layer 125, a second dielectric layer 140 (which may be part of or integrated with the emissive layer 115), a third conductive layer 145 (which may be part of or integrated with the second transmissive conductive layer 120), a color layer 130, a mask layer 155, and a protective or sealing layer 135.

In operation, and as explained in greater detail below, a voltage difference is applied between or across: (1) the third conductive layer 145 with the second transmissive conductive layer 120, and (2) the first conductive layer 110, thereby providing energy to the emissive layer 115, such as by creating a capacitive effect. The energy or power supplied to the emissive layer 115 causes incorporated light-emitting compounds, discussed below, to emit visible light (e.g., as photons, illustrated as “p” in FIG. 1). The second transmissive conductive layer 120 allows the visible light generated in the emissive layer 115 to pass through, allowing visibility of the emitted light to any observer located on the display side (i.e., the transmissive conductive layer 120 side) of the apparatus 100. As discussed in greater detail below, the third conductive layer 145 may be formed from an opaque conductor, but is configured to allow significant light transmission, while at the same time, dramatically increasing the conductivity of the second transmissive conductive layer 120. As a consequence, apparatus 100 is adapted to operate and capable of operating as a light emitting display.

Most extraordinary, the apparatus 100 may be produced to be very flat, with minimal thickness, having a depth on the order of a few sheets of paper. Indeed, the substrate layer 105 may be comprised of a single sheet of paper, for example, with all the remaining layers applied in succession with varying thicknesses through conventional printing and/or coating processes known to those of skill in the printing and coating arts. For example, working prototypes have been created using a wide variety of printing and coating processes. As a consequence, as used herein, “printing” means, refers to and includes any and all printing, coating, rolling, spraying, layering, lamination and/or affixing processes, whether impact or non-impact, currently known or developed in the future, including without limitation screen printing, inkjet printing, electro-optical printing, electroink printing, photoresist and other resist printing, thermal printing, magnetic printing, pad printing, flexographic printing, hybrid offset lithography, Gravure and other intaglio printing. All such processes are considered printing processes herein, may be utilized equivalently, and are within the scope of the present invention.

Also significant, the exemplary printing processes do not require significant manufacturing controls or restrictions. No specific temperatures or pressures are required. No clean room or filtered air is required beyond the standards of known printing processes. For consistency, however, such as for proper alignment (registration) of the various successively applied layers forming the various embodiments, relatively constant temperature (with a possible exception, discussed below) and humidity may be desirable.

A substrate (layer) 105 (and the other substrate (layers) 205, 305, 405 and 505 of the other exemplary embodiments discussed below) may be formed from virtually any material, with the suitability of any selected material determined empirically. A substrate layer 105, 205, 305, 405 and 505, without limitation of the generality of the foregoing, may comprise one or more of the following, as examples: paper, coated paper, plastic coated paper, fiber paper, cardboard, poster paper, poster board, books, magazines, newspapers, wooden boards, plywood, and other paper or wood-based products in any selected form; plastic materials in any selected form (sheets, film, boards, and so on); natural and synthetic rubber materials and products in any selected form; natural and synthetic fabrics in any selected form; glass, ceramic, and other silicon or silica-derived materials and products, in any selected form; concrete (cured), stone, and other building materials and products; or any other product, currently existing or created in the future, which provides a degree of electrical insulation (i.e., has a dielectric constant or insulating properties sufficient to provide electrical isolation of the first conductive layer 110 on that (second) side of the apparatus 100). For example, while a comparatively expensive choice, a silicon wafer also could be utilized as a substrate 105. In the exemplary embodiments, however, a plastic-coated fiber paper is utilized to form the substrate layer 105, such as the Utopia 2 paper product produced by Appleton Coated LLC, or similar coated papers from other paper manufacturers such as Mitsubishi Paper Mills, Mead, and other paper products.

The first conductive layer 110 may then be printed or coated, in any selected configuration or design, onto the substrate 105, forming one or more electrodes utilized to provide energy or power to one or more selected portions of the emissive layer 115 (such as the entire area of the emissive layer 115 or selected pixels within the emissive layer 115). The first conductive layer 110 may be created in any selected shape to have corresponding illumination, such as in a plurality of separate, electrically isolated strips (e.g., as in the second through fifth embodiments discussed below), to provide row or column selection, for discrete pixel illumination, or as a plurality of small dots for individual pixel selection, or as one or more sheets, to provide illumination of one or more sections of the emissive layer 115, as in FIG. 1. The thickness (or depth) of the first conductive layer 110 is not particularly sensitive or significant and may be empirically determined based upon the selected material and application process, requiring only sufficient thickness to conduct electricity and not have open circuits or other unwanted conduction gaps, while concomitantly maintaining the desired aspect ratio or thickness of the finished apparatus 100.

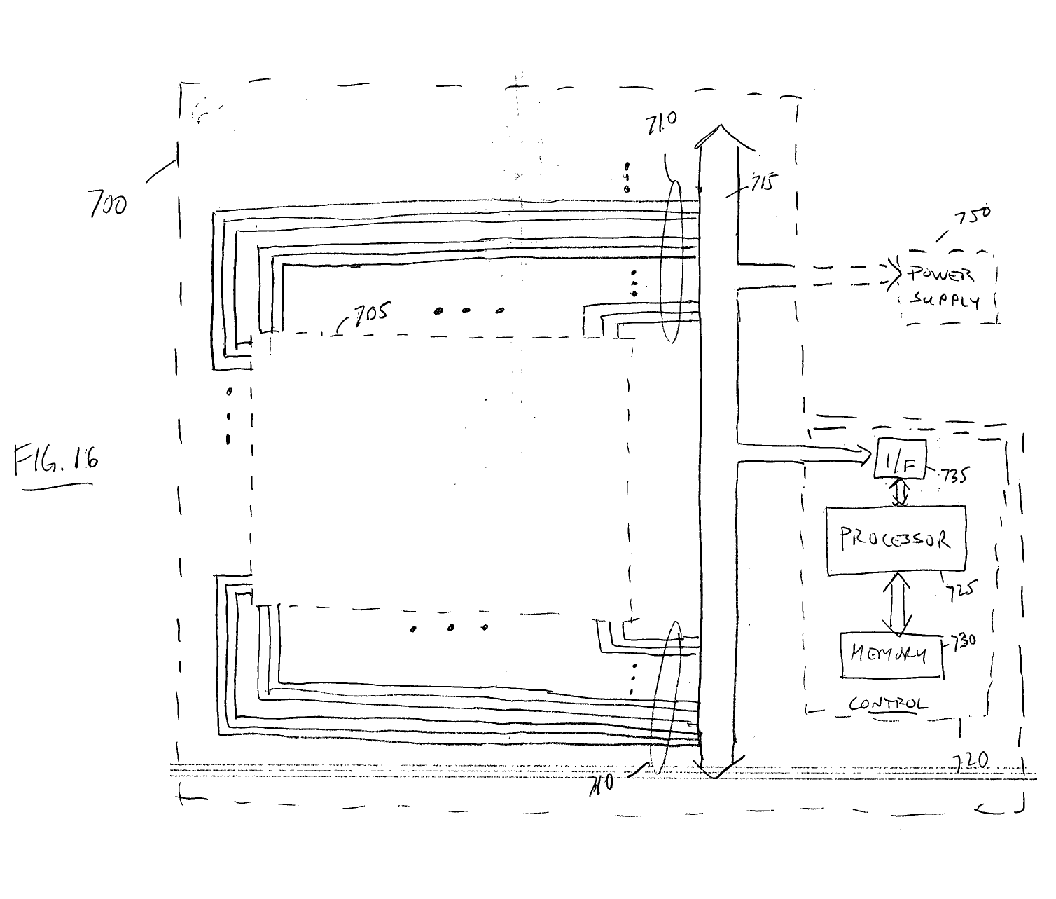

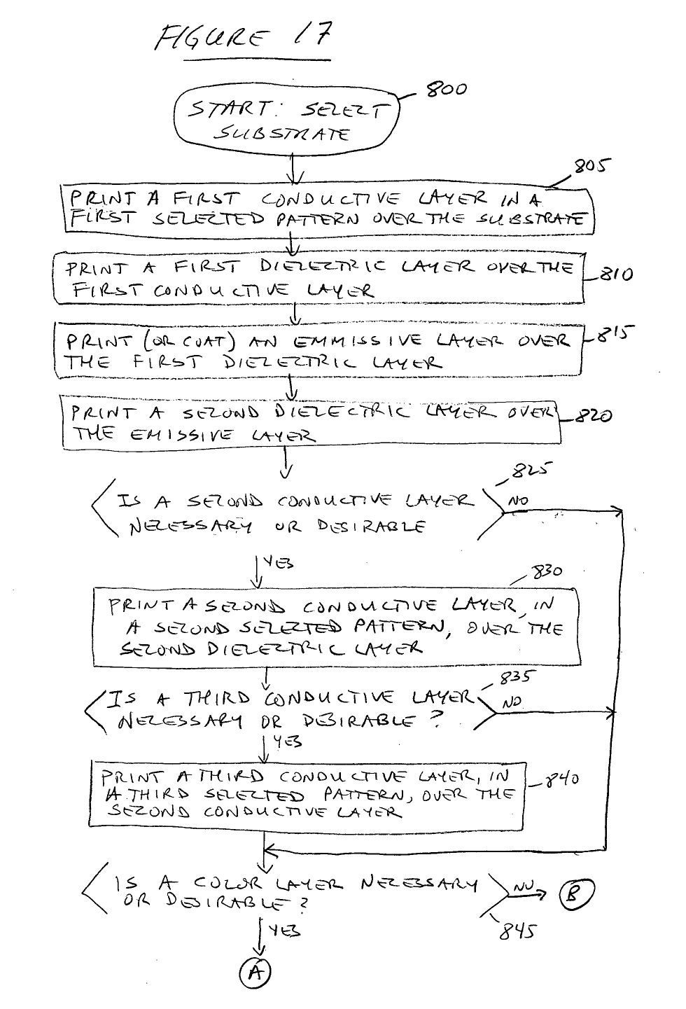

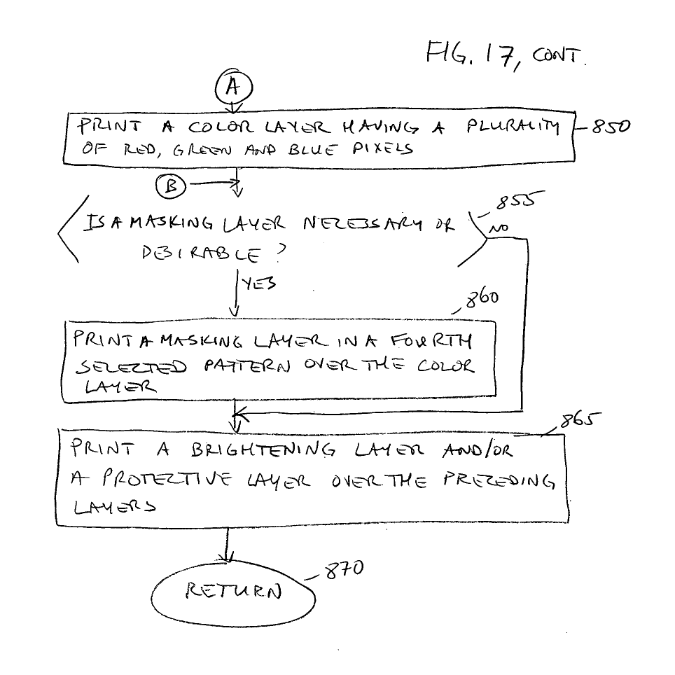

In the selected embodiments, the first conductive layer 110 (and the other first conductive layers 210, 310, 410 and 510 of the other exemplary embodiments discussed below) is formed utilizing a conductive ink, such as a silver (Ag) ink. Such a conductive ink is applied to the substrate 105 via one or the printing processes discussed above, creating the first conductive layer 110. Other conductive inks or materials may also be utilized to form the first conductive layer 110, such as copper, tin, aluminum, gold, noble metals or carbon inks, gels or other liquid or semi-solid materials. In addition, any other printable or coatable conductive substances may be utilized equivalently to form the first conductive layer 110, and exemplary conductive compounds include: (1) From Conductive Compounds (Londonberry, N.H., USA), AG-500, AG-800 and AG-510 Silver conductive inks, which may also include an additional coating UV-1006S ultraviolet curable dielectric (such as part of a first dielectric layer 125); (2) From DuPont, 7102 Carbon Conductor (if overprinting 5000 Ag), 7105 Carbon Conductor, 5000 Silver Conductor (also for bus 710, 715 of FIG. 16 and any terminations), 7144 Carbon Conductor (with UV Encapsulants), 7152 Carbon Conductor (with 7165 Encapsulant), and 9145 Silver Conductor (also for bus 710, 715 of FIG. 16 and any terminations); (3) From SunPoly, Inc., 128A Silver conductive ink, 129A Silver and Carbon Conductive Ink, 140A Conductive Ink, and 150A Silver Conductive Ink; and (4) From Dow Corning, Inc., PI-2000 Series Highly Conductive Silver Ink. As discussed below, these compounds may also be utilized to form third conductive layer 145. In addition, conductive inks and compounds may be available from a wide variety of other sources.

After the conductive ink or other substance has dried or cured on the substrate 105, these two layers may be calendarized as known in the printing arts, in which pressure and heat are applied to these two layers 105 and 110, tending to provide an annealing affect on the first conductive layer 110 for improved conduction capabilities. In the other exemplary embodiments discussed below, the other first conductive layers 210, 310, 410 and 510 may be created identically to the first conductive layer 110. The resulting thickness of the first conductive layer 110 is generally in the range of 1-2 microns.

If the first conductive layer 110 is provided in one or more parts or portions, then the apparatus 100 (as it is being formed) should be properly aligned or registered, to provide that the conductive inks are printed to the desired or selected level of precision or resolution, depending on the selected embodiment. For example, in the fourth exemplary embodiment discussed below, the corresponding first conductive layer 410 is utilized to create multiple, electrically isolated electrodes (cathodes and anodes), which may be formed during one printing cycle; if created in more than one cycle, the substrate 105 and the additional layers should be correspondingly and properly aligned, to provide that these additional layers are placed correctly in their selected locations. Similarly, as additional layers are applied to create the apparatus 100 (200, 300, 400 or 500), such as the transmissive conductive layer 120 and the third conductive layer 145, such proper alignment and registration are also important, to provide for proper pixel selection using corresponding pixel addressing, as may be necessary or desirable for a selected application.

The first dielectric layer 125 may be coated or printed over the first conductive layer 110, with the emissive layer 115 coated or printed over the dielectric layer 125. As illustrated in FIGS. 1 and 2, the dielectric layer 125 is utilized to provide additional smoothness and/or affect the dielectric constant of the emissive layer 115. For example, in the selected exemplary apparatus embodiment 100, a coating of barium titanate (BaTiO₃) and/or titanium dioxide is utilized, both to provide for smoothness for printing of additional layers, and to adjust the dielectric constant of the electroluminescent compound in the emissive layer 115. For such an exemplary embodiment, 1-2 printing coats or layers of barium titanate and/or titanium dioxide are applied, with each coating being substantially in the 6 micron range for barium titanate and for titanium dioxide, approximately, to provide an approximately 10-12 micron dielectric layer 125, with a 12 micron dielectric layer 125 utilized in the various exemplary embodiments. In addition, a second dielectric layer 140 (formed of the same materials as layer 125) may also be included as part of the emissive layer 115, or applied as an additional layer.

A wide variety of dielectric compounds may be utilized to form the various dielectric layers, and all are within the scope of the present invention. Exemplary dielectric compounds utilized to form the dielectric layers include, without limitation: (1) From Conductive Compounds, a barium titanate dielectric; (2) From DuPont, 5018A Clear UV Cure Ink, 5018G Green UV Cure Ink, 5018 Blue UV Cure Ink, 7153 High K Dielectric Insulator, and 8153 High K Dielectric Insulator; (3) From SunPoly, Inc., 305D UV Curable dielectric ink and 308D UV Curable dielectric ink; and (4) from various supplies, Titanium Dioxide-filled UV curable inks

The emissive layer 115 is then applied, such as through printing or coating processes discussed above, over the first dielectric layer 125. The emissive layer 115 may be formed of any substance or compound capable of or adapted to emit light in the visible spectrum (or other electromagnetic radiation at any selected frequency) in response to an applied electrical field, such as in response to a voltage difference supplied to the first conductive layer 110 and the transmissive conductive layer 120. Such electroluminescent compounds include various phosphors, which may be provided in any of various forms and with any of various dopants, such as copper, magnesium, strontium, cesium, etc. One such exemplary phosphor is a zinc sulfide (ZnS-doped) phosphor, which may be provided in an encapsulated form for ease of use, such as the micro-encapsulated ZnS-doped phosphor encapsulated powder from the DuPont™ Luxprint® electroluminescent polymer thick film materials. This phosphor may also be combined with a dielectric such as barium titanate or titanium dioxide, to adjust the dielectric constant of this layer, may be utilized in a polymer form having various binders, and also may be separately combined with various binders (such as phosphor binders available from DuPont or Conductive Compounds), both to aid the printing or other deposition process, and to provide adhesion of the phosphor to the underlying and subsequent overlying layers.

A wide variety of equivalent electroluminescent compounds are available and are within the scope of the present invention, including without limitation: (1) From DuPont, 7138J White Phosphor, 7151J Green-Blue Phosphor, 7154J Yellow-Green Phosphor, 8150 White Phosphor, 8152 Blue-Green Phosphor, 8154 Yellow-Green Phosphor, 8164 High-Brightness Yellow-Green and (2) From Osram, the GlacierGlo series, including blue GGS60, GGL61, GGS62, GG65; blue-green GGS20, GGL21, GGS22, GG23/24, GG25; green GGS40, GGL41, GGS42, GG43/44, GG45; orange type GGS10, GGL11, GGS12, GG13/14; and white GGS70, GGL71, GGS72, GG73/74.

When the selected micro-encapsulated ZnS-doped phosphor encapsulated powder electroluminescent material is utilized to form the emissive layer 115, the layer should be formed to be approximately 20-45 microns thick (12 microns minimum), or to another thickness which may be determined empirically when other electroluminescent compounds are utilized. When other phosphors or electroluminescent compounds are utilized, the corresponding thickness should be empirically determined to provide sufficient thickness for no dielectric breakdown, and sufficient thinness to provide comparatively high capacitance. Again, as in the creation or development of the other layers forming the various exemplary embodiments, such as apparatus 100, the emissive layer 115 may be applied using any printing or coating process, such as those discussed above. As mentioned above, the emissive layer 115 may also incorporate other compounds to adjust the dielectric constant and/or to provide binding, such as the various dielectric compounds discussed above.

In the other exemplary embodiments discussed below, the other emissive layers 215, 315, 415 and 515 may be created identically to the emissive layer 115. In addition, an additional layer can be and generally is included between the corresponding emissive layer and the corresponding overlaying transmissive conductive layer, such as a coating layer to provide additional smoothness and/or affect the dielectric constant of the emissive layer. For example, in the various exemplary embodiments, a coating of barium titanate (BaTiO₃), titanium dioxide (TiO₂), or a mixture of barium titanate and titanium dioxide, is utilized, both to provide for smoothness for printing of additional layers, and to reduce the dielectric constant of the selected electroluminescent compound from about 1500 to closer to 10. For such an exemplary embodiment, 2-3 printing coats or layers of barium titanate and/or titanium dioxide are applied, with each coating being substantially in the 6 micron range for barium titanate and for titanium dioxide, approximately.

In addition, depending upon the selected embodiment, colorants, dyes and/or dopants may be included within any such emissive layer. In addition, the phosphors or phosphor capsules utilized to form an emissive layer may include dopants which emit in a particular spectrum, such as green or blue. In those cases, the emissive layer may be printed to define pixels for any given or selected color, such as RGB or CMY, to provide a color display.

Following application of the emissive layer 115 (and any other additional layers discussed below), the second, transmissive conductive layer 120 is applied, such as through printing or coating processes discussed above, over the emissive layer 115 (and any additional layers). The second, transmissive conductive layer 120, and the other transmissive conductive layers (220, 320, 420 and 520) of the other exemplary embodiments, may be comprised of any compound which: (1) has sufficient conductivity to energize selected portions of the apparatus in a predetermined or selected period of time; and (2) has at least a predetermined or selected level of transparency or transmissibility for the selected wavelength(s) of electromagnetic radiation, such as for portions of the visible spectrum. For example, when the present invention is utilized for a static display, the conductivity time or speed in which the transmissive conductive layer 120 provides energy across the display to energize the emissive layer 115 is comparatively less significant than for other applications, such as for active displays of time-varying information (e.g., computer displays). As a consequence, the choice of materials to form the second, transmissive conductive layer 120 may differ, depending on the selected application of the apparatus 100.

As discussed above, this transmissive conductive layer 120 (and the other transmissive conductive layers 220, 320, 420 and 520) is applied to the previous layer of the corresponding embodiment using a conventional printing or coating process, with proper control provided for any selected alignment or registration. For example, in the various exemplary embodiments discussed below, a transmissive conductive layer is utilized to create multiple, electrically isolated electrodes (individual transparent wires or dots), which may be formed during one or more printing cycles, and which should be properly aligned in comparison with the electrodes of the first conductive layer 110, to provide for proper pixel selection using corresponding pixel addressing, as may be necessary or desirable for a selected application. In other applications, such as for static displays or signage, in which the transmissive conductive layer 120 may be a unitary sheet, for example, such alignment issues are comparatively less significant.

In the exemplary embodiment of apparatus 100, antimony tin oxide (ATO) is utilized to form the second, transmissive conductive layer 120 (and the other transmissive conductive layers 220, 320, 420 and 520 of the other exemplary embodiments). While ATO provides sufficient transparency for visible light, its impedance or resistance is comparatively high (e.g., 20 kΩ), generating a correspondingly comparatively high (i.e., slow) time constant for electrical transmission across this layer of the apparatus 100, such as down a corresponding electrode. As a consequence, in some of the exemplary embodiments, a third conductor (third conductive layer 145) having a comparatively lower impedance or resistance is or may be incorporated into this second, transmissive conductive layer 120 (and the other transmissive conductive layers (220, 320, 420 and 520 of the other exemplary embodiments), to reduce the overall impedance or resistance of this layer, decrease conduction time, and increase the responsiveness of the apparatus to changing information (see, e.g., FIG. 12). For example, fine wires may be formed using a conductive ink printed over corresponding strips or wires of the second, transmissive conductive layer 120, to provide for increased conduction speed throughout the second, transmissive conductive layer 120. Other compounds which may be utilized equivalently to form the transmissive conductive layer 120 (220, 320, 420, 520) include indium tin oxide (ITO), and other transmissive conductors as are currently known or may become known in the art. Representative transmissive conductive materials are available, for example, from DuPont, such as 7162 and 7164 ATO translucent conductor.

As mentioned above, in operation, a voltage difference is applied across (1) the second, transmissive conductive layer 120 (and/or the third conductive layer 145) and (2) the first conductive layer 110, thereby providing energy to the emissive layer 115, such as by creating a capacitive effect. The supplied voltage is in the form of alternating current (AC) in the exemplary embodiments, having a frequency range of approximately or substantially 400 Hz to 2.5 kHz, while other equivalent embodiments may be capable of using direct current. The supplied voltage is generally over 60 Volts, and may be higher (closer to 100 V) for lower AC frequencies. Current consumption is in the pico-Ampere range, however, resulting in overall low power consumption, especially when compared to other types of displays (e.g., active matrix LCD displays). The supplied voltage should correspond to the type of electroluminescent compounds used in the emissive layer 115, as they may have varying breakdown voltages and may emit light at voltages different from that specified above. The energy or power supplied to the emissive layer 115 causes (ballistic) electron motion within the incorporated electroluminescent compounds, which then emit visible light (e.g., as photons) at selected frequencies, depending upon the corresponding bandgap(s) of the particular or selected dopant(s) utilized within a selected electroluminescent compound. As the emitted light passes through the transmissive conductive layer 120 for corresponding visibility, the apparatus 100 is adapted to operate and is capable of operating as a light emitting display.

Following application of the second, transmissive conductive layer 120, additional coatings or layers may also be applied to the apparatus 100, in addition to a third conductive layer. As discussed in greater detail below, color layers, filters, and/or dyes may be applied, as one or more layers or as a plurality of pixels or subpixels, such as through the printing processes previously discussed. A calcium carbonate coating may also be applied, to increase display brightness. Other transparent or transmissive protective or sealant coatings may also be applied, such as an ultraviolet (uv) curable sealant coating.

Also illustrated in FIGS. 1 and 2, a third conductive layer 145 may be incorporated within, coated or printed onto, or otherwise provided as the next layer on top of the transmissive conductive layer 120. As discussed above, such a third conductive layer may be fabricated using a conductive ink, may have appreciably lower impedance, and may be printed as fine lines (forming corresponding fine wires) on top of the transmissive conductive layer 120, to provide for increased conduction speed within and across the transmissive conductive layer 120.

This use of a third conductive layer in the various inventive embodiments is significant and novel. Prior art EL displays have been incapable of displaying real time information, in part due to their structures which lack addressing capability, but also in part to the high impedance and low rate of conduction through the typical transmissive layer, particularly when ITO is utilized. Because of such high impedance and low conductivity, energy transmission through such a transmissive layer has a large time constant, such that a transmissive layer of the prior art cannot be energized sufficiently quickly to provide energy to the emissive layer and accommodate rapidly changing pixel selection and display of changing information. The use of the third conductive layer 145 overcomes this difficulty with prior art displays, and with other novel features and structures of the invention, allows the various inventive embodiments to display changing information in real time.

Following application of the second, transmissive conductive layer 120 and any third conductive layer 145, a color layer 130 is printed or coated, to provide corresponding coloration for the light emitted from the emissive layer 115. Such a color layer 130 may be comprised of one or more color dyes, color fluorescent dyes, color filters, in a unitary sheet, as a plurality of pixels or subpixels, such as through the printing processes previously discussed.

In selected embodiments, a plurality of fluorescent dyes are utilized to provide the color layer (e.g., color layer 130, 230, 330, 530, 630), resulting in several important features and advantages of the present invention. First, the use of fluorescent dyes provides for a greater perceived light output, and possibly less actual photon absorption and higher actual light (lumen) output per watt. This is a significant advantage because, for the same input power, the various embodiments provide significantly greater illumination compared to prior art displays, even visible in daylight. In addition, this greater brightness concomitantly allows for increased resolution, as perceived by an observer. Moreover, the use of fluorescent dyes provides subtractive coloration, due to the light transmission through the pigment, and retains white emission, also serving to potentially increase brightness.

Following application of the color layer 130, one or more additional protective or sealing layers 135 are applied, such as a calcium carbonate coating, followed by other transparent or transmissive protective or sealant coatings, such as an ultraviolet (uv) curable sealant coating.

Continuing to refer to FIGS. 1 and 2, another apparatus 100 embodiment variation is also available. In this alternative embodiment, masking (or black-out layer) 155 is utilized, overlaying color layer 130, and applied before any protective or sealing layers 135. For this display embodiment, each of the underlying layers (substrate layer 105, the first conductive layer 110, dielectric layer 125, the emissive layer 115, any additional dielectric layer 140, second transmissive conductive layer 120, any third conductive layer 145, and color layer 130) is applied or provided as a unitary, complete sheet, extending substantially over the width and length of the apparatus 100 (with the exception of providing room or otherwise ensuring access points to energize the first conductive layer 110, the second transmissive conductive layer 120 and any third conductive layer 145). The color layer is applied with each red, green or blue (“RGB”) (or an other color scheme, such as cyan, magenta, yellow, and black (“CMYK”)) representing a subpixel (or pixel). This portion of the apparatus 100 variation may be mass produced, followed by customization or other individualization through the use of the masking layer 155.

Following application of the color layer 130, the masking layer 155 is applied in a pattern such that masking is applied over any subpixels or pixels which are not to be visible (i.e., are masked) in the resulting display, and in predetermined combinations to provide proper color resolution when perceived by an ordinary observer. For example, opaque (such as black) dots of varying sizes may be provided, such as through the printing processes discussed above, with proper registration or alignment with the underlying red/green/blue subpixels. With this masking layer 155 applied, only those non-masked pixels will be visible through the overlaying protective or sealing layers 135. Using this variation, a back-lit display is provided, which may be customized during later fabrication stages, rather than earlier in the process. In addition, such a color, back-lit display may also provide especially high resolution, typically higher than that provided by a color RGB or CMY display.

As a light emitting display, the various embodiments of the invention have highly unusual properties. First, they may be formed by any of a plurality of conventional and comparatively inexpensive printing or coating processes, rather than through the highly involved and expensive semiconductor fabrication techniques, such as those utilized to make LCD displays, plasma displays, or ACTFEL displays. For example, the present invention does not require clean rooms, epitaxial silicon wafer growth and processing, multiple mask layers, stepped photolithography, vacuum deposition, sputtering, ion implantation, or other complicated and expensive techniques employed in semiconductor device fabrication.

Second, the invention may be embodied using comparatively inexpensive materials, such as paper and phosphors, substantially reducing production costs and expenses. The ease of fabrication using printing processes, combined with reduced materials costs, may revolutionize display technologies and the industries which depend upon such displays, from computers to mobile telephones to financial exchanges.

Third, the various embodiments are scalable, virtually limitlessly. For example, the various embodiments may be scaled up to wallpaper, billboard or larger size, or down to cellular telephone or wristwatch display size.

Fourth, at the same time, the various embodiments have a substantially flat form factor, with the total display thickness in the range of 50-55 microns, plus the additional thickness of the selected substrate. For example, using 3 mill paper (approximately 75 microns thick), the thickness of the resulting display is on the order of 130 microns, providing one of, if not the, thinnest addressable display to date.

Fifth, the various embodiments provide a wide range of selectable resolutions. For example, the printing processes discussed above can provide resolutions considerably greater than 220 dpi (dots per inch), which is the resolution of high density television (HDTV), and may provide higher resolutions with ongoing device development.

Sixth, as has been demonstrated with various prototypes, the various exemplary embodiments are highly and unusually robust. Prototypes have been folded, torn, and otherwise maltreated, while still retaining significant (if not all) functionality.

Numerous other significant advantages and features of the various embodiments of the invention will be apparent to those of skill in the art.

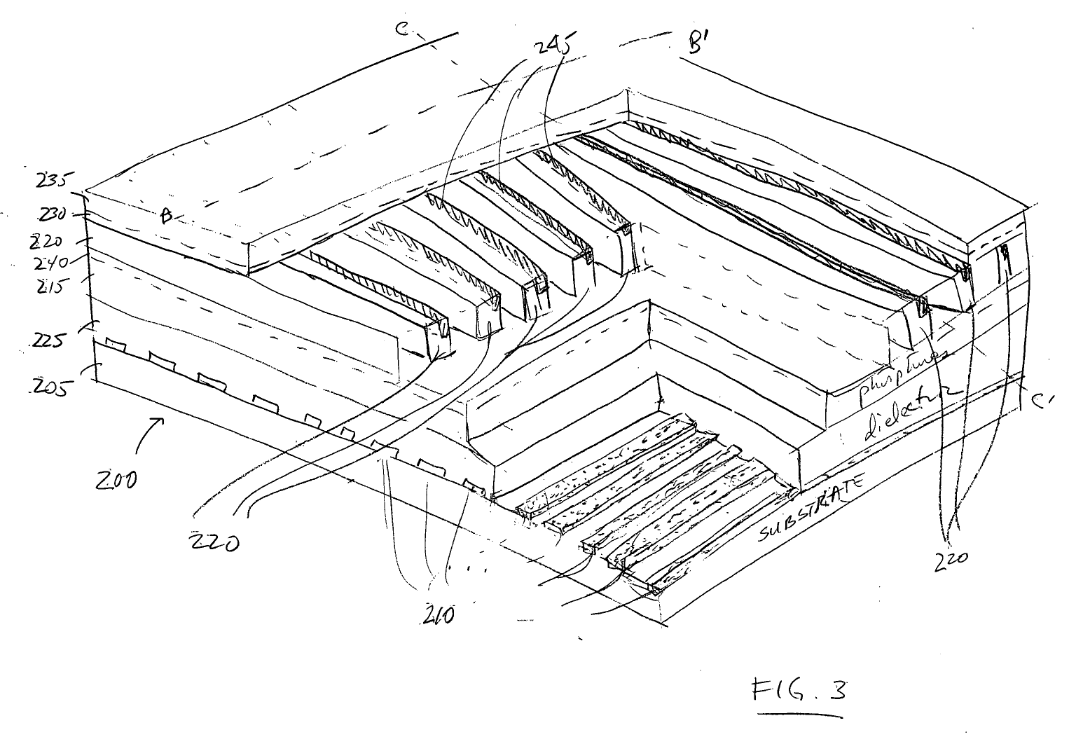

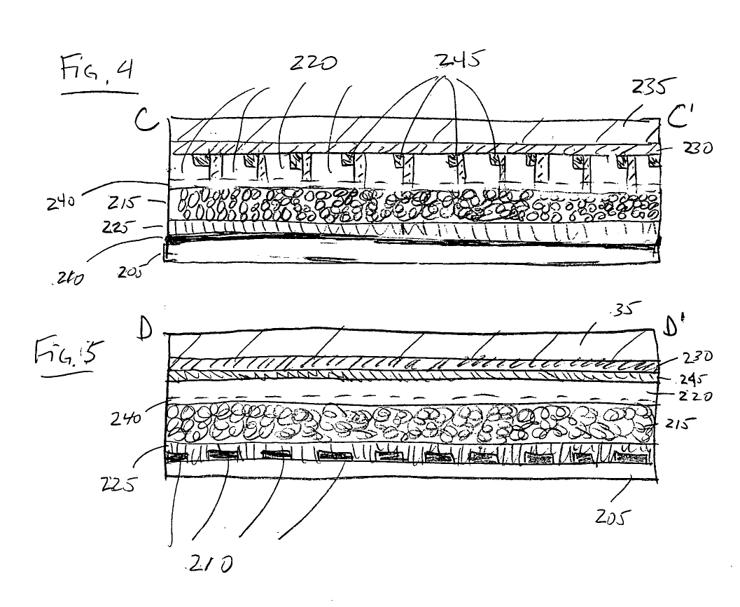

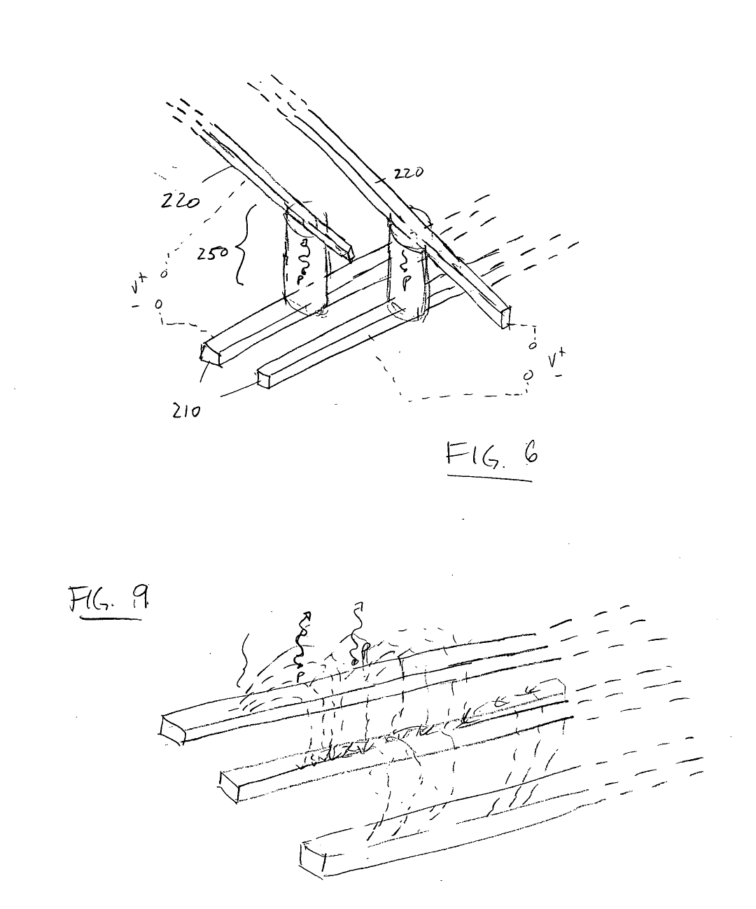

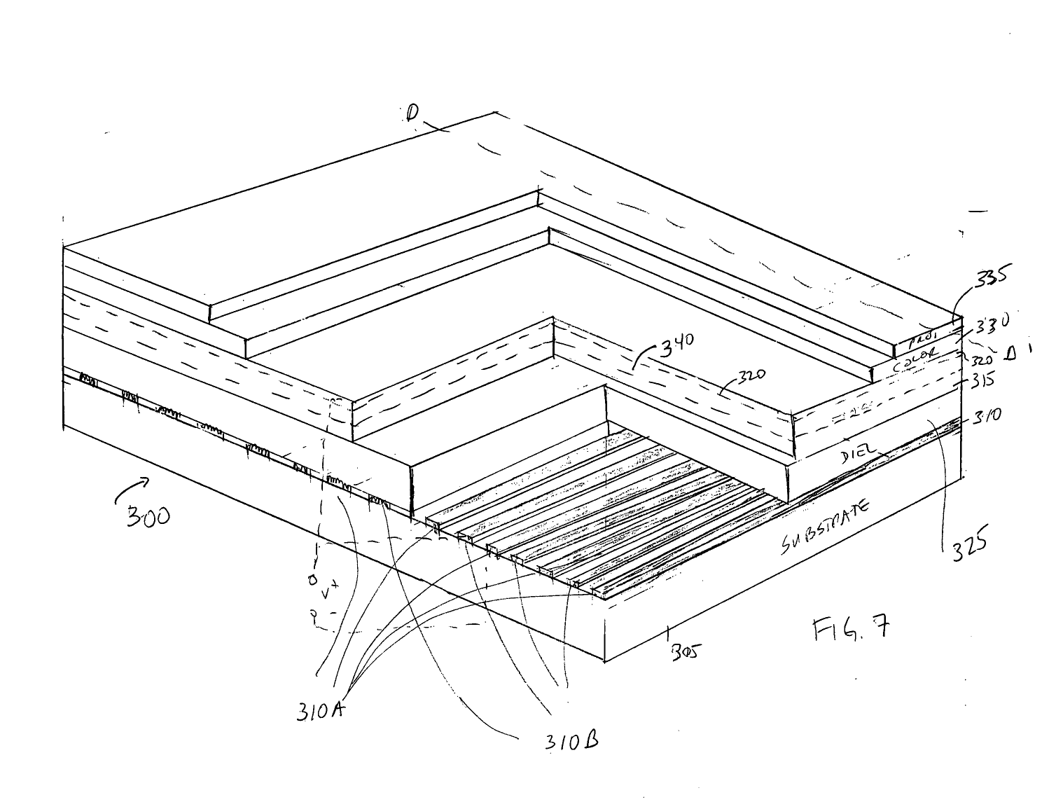

FIG. 3 (or FIG. 3) is a perspective view of a second exemplary apparatus embodiment 300 in accordance with the teachings of the present invention. FIG. 4 (or FIG. 4) is a cross-sectional view of the second exemplary apparatus embodiment 200 in accordance with the teachings of the present invention, through the B-B′ plane of FIG. 3. FIG. 5 (or FIG. 5) is a cross-sectional view of the second exemplary apparatus embodiment 200 in accordance with the teachings of the present invention, through the C-C′ plane of FIG. 3. FIG. 6 (or FIG. 6) is a perspective view of an exemplary emissive region (or pixel) of the second exemplary apparatus embodiment 200 in accordance with the teachings of the present invention. As discussed in greater detail below, the exemplary apparatus 200 is adapted to and capable of functioning as a dynamic display, with individually addressable light-emitting pixels, for the display of either static or time-varying information.

Referring to FIGS. 3-6, the apparatus 200 includes different structures for the first conductive layer 210, second transmissive conductive layer 220, and third conductive layer 245. The first conductive layer 210, second transmissive conductive layer 220, and third conductive layer 245 may be formed of the same materials as their respective counterparts previously discussed (the first conductive layer 110, second transmissive conductive layer 120, and third conductive layer 145). Also, the remaining layers of apparatus 200, namely, the substrate layer 205, the dielectric layers 225 and 240, the emissive layer 215, the color layer 230 (and any masking layer (not separately illustrated), and coating layer 235, may be formed of the same materials, may have the same configuration as, and may otherwise be identical to their respective counterparts (substrates 105, dielectric layers 125 and 140, emissive layer 115, color layer 130, and coating layer 135) previously discussed.

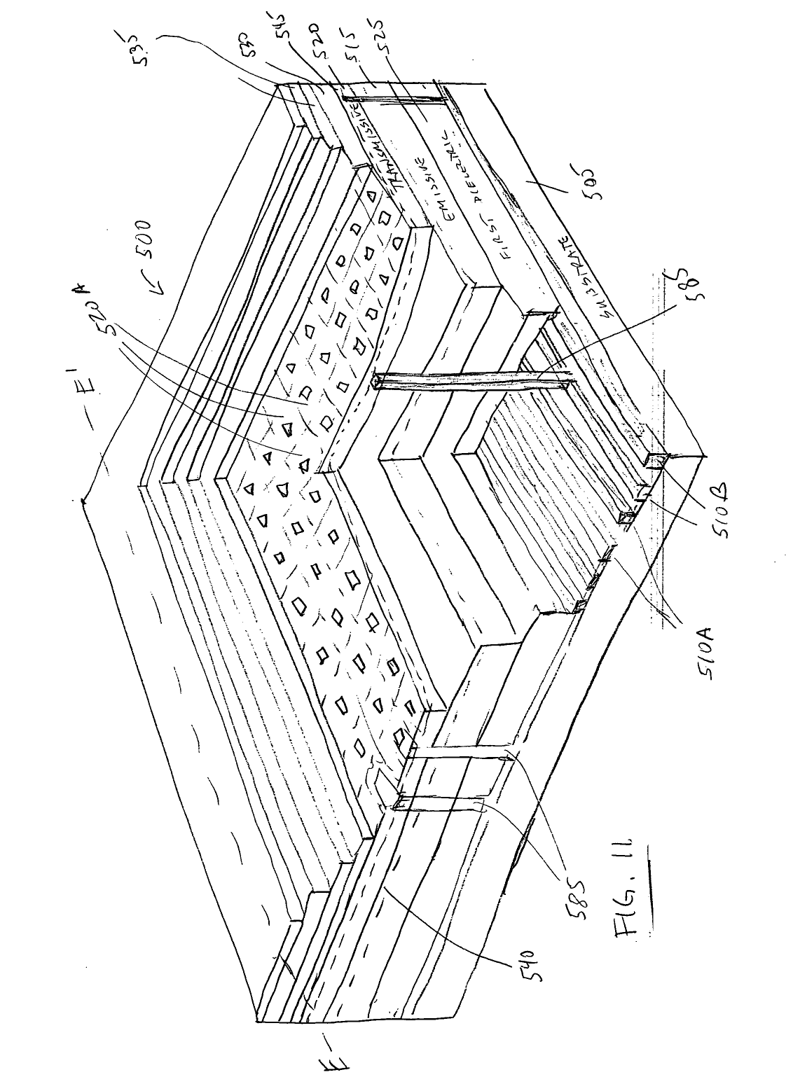

As illustrated in FIGS. 3-6, the first conductive layer 210 is formed as a first plurality of electrically isolated (or insulated) electrodes, such as in the form of strips or wires, which also may be spaced apart, all running in a first direction, such as parallel to the B-B′ plane, (e.g., forming “rows”). The second transmissive conductive layer 220 is also formed as a second plurality of electrically isolated (or insulated) electrodes, such as in the form of transmissive strips or wires, which also may be spaced apart, all running in a second direction different than the first direction (e.g., forming “columns”), such as perpendicular to the B-B′ plane (or, not illustrated, at any angle to the first direction sufficient to provide the selected resolution level for the apparatus 200). The third conductive layer 245 is also formed as a plurality of strips or wires, embedded or included within the second transmissive conductive layer 220, and is utilized to decrease conduction time through the second transmissive conductive layer 220. (An exemplary third conductive layer disposed within a second conductive layer is discussed below with reference to FIG. 10).

As illustrated in FIG. 6, when voltage difference is applied to a first electrode of the first plurality of electrodes from the first conductive layer 210 and a second electrode of the second plurality of electrodes from the second transmissive conductive layer 220, a corresponding region within the emissive layer 215 is energized to emit light, forming a pixel 250. Such a selected pixel is individually and uniquely addressable by selection of the corresponding first and second electrodes, such as through row and column addressing known in the LCD display and semiconductor memory fields. More particularly, selection of a first electrode, as a row, and a second electrode, as a column, through application of corresponding electrical potentials, will energize the region of the emissive layer 215 approximately or substantially at the intersection of the first and second electrodes, as illustrated in FIG. 6, providing addressability at a pixel level. With the addition of a color layer, such intersections may correspond to a particular color (e.g., red, green or blue) which may be combined with other addressed pixels to create any selected color combination, providing addressing at a subpixel level.

It will be apparent to those of skill in the art that, in addition to or in lieu of row and column pixel/subpixel addressing, additional addressing methods are also available and are within the scope of the present invention. For example, while not separately illustrated, the various embodiments of the present invention may be configured to provide a form or version of raster scanning or addressing.

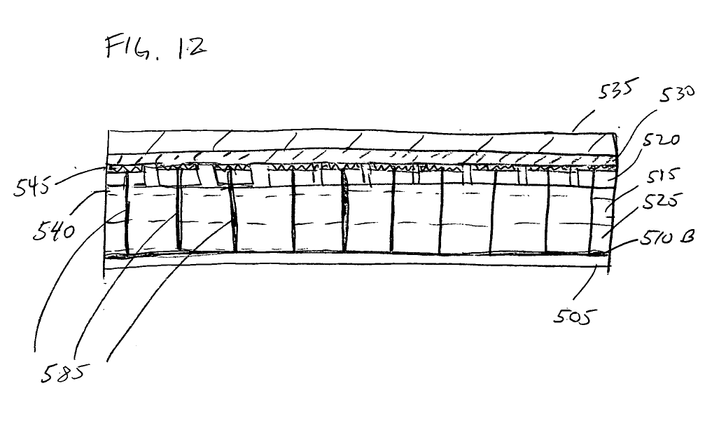

In addition, it will also be apparent to those of skill in the electronics and printing arts that the various first, second and/or third conductive layers, and the various dielectric layers, of any of the embodiments of the invention, may be applied or printed in virtually unlimited patterns in all three spatial dimensions with accurate registration and alignment. For example, and as discussed below with respect to FIG. 11, the various conductive layers may be applied within other layers, in the nature of an electronic “via” in the depth or “z” direction, to provide for accessing and energizing second or third conductive layers from the same layer as the first conductive layer, to provide addition methods for individual pixel and subpixel addressing.

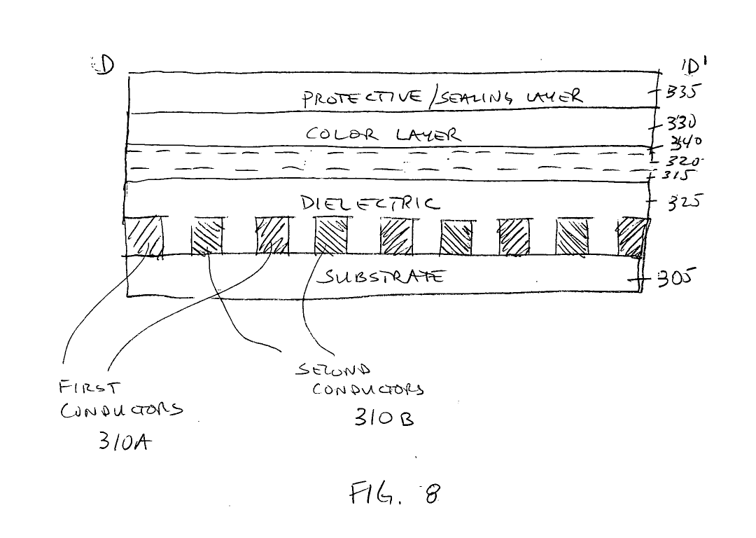

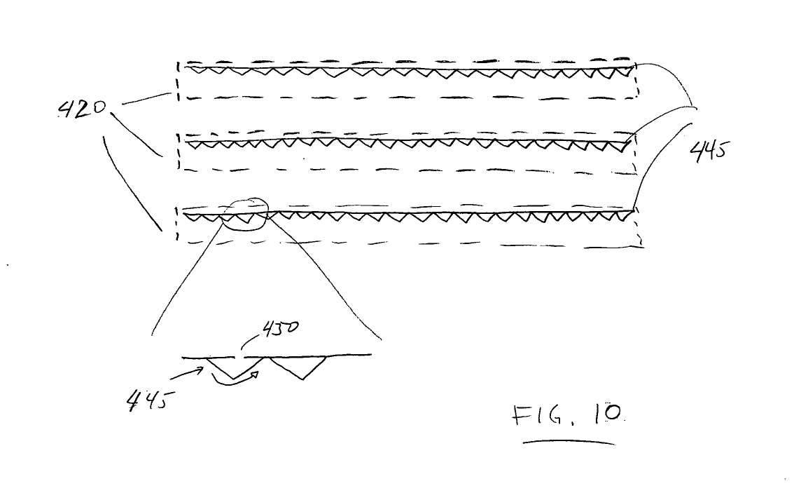

FIG. 7 (or FIG. 7) is a perspective view of a third exemplary apparatus embodiment 300 in accordance with the teachings of the present invention. FIG. 8 (or FIG. 8) is a cross-sectional view of the third exemplary apparatus embodiment 300 in accordance with the teachings of the present invention, through the D-D′ plane of FIG. 7. FIG. 9 (or FIG. 9) is a perspective view of an emissive region of the third exemplary embodiment 300 in accordance with the teachings of the present invention.

Referring to FIGS. 7-9, the apparatus 300 includes different structures for the first conductive layer 310, and does not include a third conductive layer. The first conductive layer 310 and the second conductive layer 320 may be formed of the same materials as their respective counterparts previously discussed (the first conductive layers 110, 210 and second conductive layer 120, 220). Also, the remaining layers of apparatus 300, namely, the substrate layer 305, the dielectric layers 325 and 340, the emissive layer 315, the color layer 330, and coating layer 335, may be formed of the same materials, may have the same configuration as, and may otherwise be identical to their respective counterparts (substrates 105, 205, dielectric layers 125, 225, 140, 240, emissive layers 115, 215, color layer 130, 230, and coating layer 135, 235) previously discussed.

Referring to FIGS. 7 and 8, the first conductive layer 310 is also formed as a plurality of electrically isolated (or insulated) electrodes, such as in the form of strips or wires, which also may be spaced apart. While illustrated as straight, parallel electrodes, it should be understood that the electrodes may have a wide variety of shapes and configurations, such as sinusoidal, provided adjacent electrodes are electrically isolated from each other. The electrodes of the conductive layer 310 are divided into two groups, first conductors or electrodes 310A, and second conductors or electrodes 310B. One of the groups (310A or 310B) is electrically coupled to the second transmissive layer 320. Prototypes have demonstrated that when a voltage difference is applied between or across the first electrodes 310A and second electrodes 310B, with one set of the electrodes (310A or 310B (exclusive or)) electrically coupled to the second transmissive layer 320, the emissive layer 315 is energized and emits light, illustrated using electric field (dashed) lines in FIG. 9. As the emitted light passes through the optional color layer 330 and optional protective layer 335, the apparatus 300 is adapted to operate and is capable of operating as a light emitting display.

FIG. 10 (or FIG. 10) is a top view of an exemplary embodiment of a third conductor (conductive layer) 445 disposed within a second, transmissive conductor (conductive layer) 420 of the various exemplary embodiments in accordance with the teachings of the present invention. As illustrated, the third conductive layer 445, which also may be printed using a conductive ink, such as those discussed above, provides two conductive paths in any particular region, throughout the length of the particular (electrically isolated) second transmissive conductive layer 420. In the event a gap (open circuit) 450 occurs in one of the conductive paths, current can flow through the second path, providing redundancy for increased robustness.

FIG. 11 (or FIG. 11) is a perspective view of a fourth exemplary apparatus embodiment 500 in accordance with the teachings of the present invention. FIG. 12 (or FIG. 12) is a cross-sectional view of the fourth exemplary apparatus embodiment in accordance with the teachings of the present invention, through the E-E′ plane of FIG. 11. Referring to FIGS. 11 and 12, the apparatus 500 includes many of the layers previously discussed, namely, the substrate layer 505, the dielectric layers 525 and 540, the emissive layer 515, the color layer 530, and coating layer 535, may be formed of the same materials, may have the same configuration as, and may otherwise be identical to their respective counterparts (substrates 105, 205, 305, dielectric layers 125, 140, 225, 240, 325, 340, emissive layers 115, 215, 315, color layer 130, 230, 330, and coating layer 135, 235, 335) previously discussed. In addition, the first conductive layer 510A and 510B, the second conductive layer 520, and the third conductive layer 545, may be formed of the same materials previously discussed for their respective counterparts (first conductive layer 110, 210, 310A, 310B, the second conductive layer 120, 220, 320, 420, and the third conductive layer 145, 245, 345, 445). Apparatus 500 is also similar to 300, insofar as the first conductive layer 510 is comprised of a first group of electrodes 510A, and a second group of electrodes 510B, which are electrically isolated from each other.

Continuing to refer to FIGS. 11 and 12, apparatus 500 provides for the second conductive layer 520 and third conductive layer 545 to be formed into small regions (or pixels) 520A, which may be continuous or abutting or which may be electrically isolated or insulated from each other (such as through additional dielectric material being included in that layer). Different regions 520A of the second conductive layer 520 and third conductive layer 545 are coupled to one of the two groups of electrodes of the first conductive layer 510, illustrated as connected through the second group of electrodes 510B, through “via” connections 585. These via connections 585 may be built up through the intervening layers (525, 515, 540) through printing corresponding layers of a conductive ink, for example, or other fabrication techniques, within these other intervening layers, providing a stacking or otherwise vertical arrangement to form an electrically continuous conductor. This apparatus 500 configuration allows selective energizing of the second conductive layer 520 and third conductive layer 545, on a regional or pixel basis, through electrical connections made at the level of the first conductive layer 510.

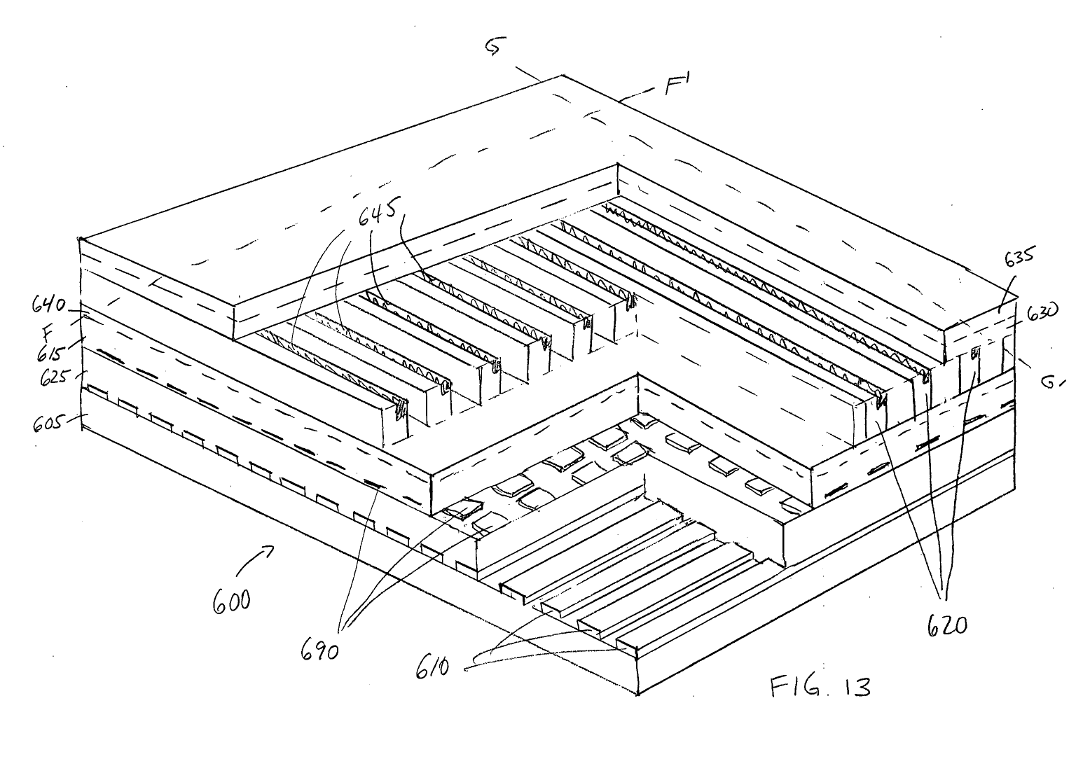

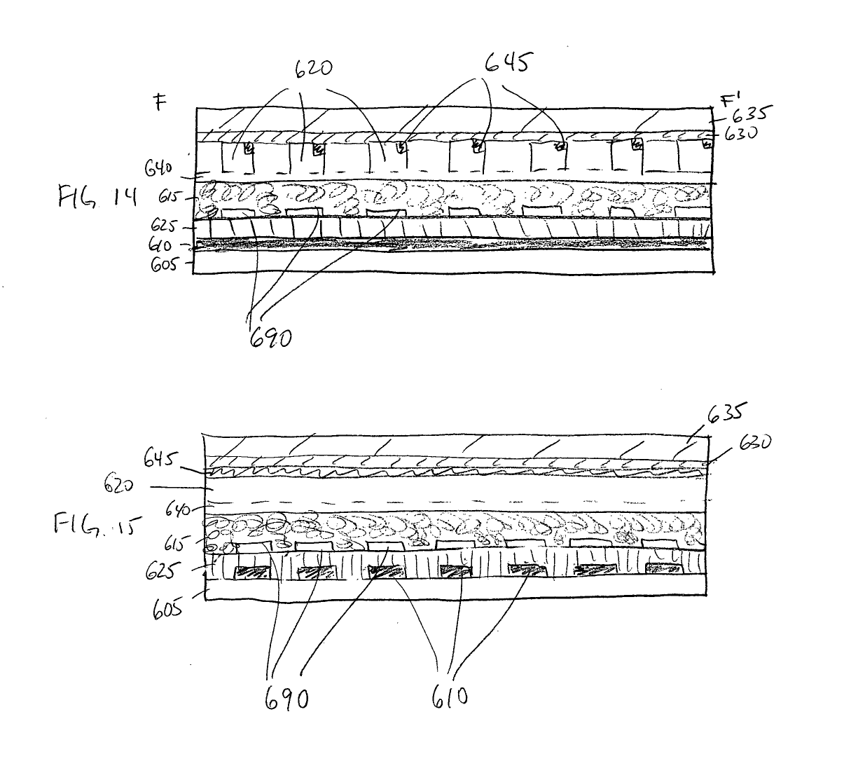

FIG. 13 (or FIG. 13) is a perspective view of a fifth exemplary apparatus 600 embodiment in accordance with the teachings of the present invention. FIG. 14 (or FIG. 14) is a cross-sectional view of the fifth exemplary apparatus 600 embodiment in accordance with the teachings of the present invention, through the F-F′ plane of FIG. 13. FIG. 15 (or FIG. 15) is a cross-sectional view of the fifth exemplary apparatus 600 embodiment in accordance with the teachings of the present invention, through the G-G′ plane of FIG. 13.

Referring to FIGS. 13-15, the apparatus 600 is highly similar to apparatus 200, with the additional feature of a plurality of reflective elements or reflective interfaces (or surfaces) 690 printed or coated above the first dielectric layer 625 and below or within the emissive layer 615. In selected embodiments, each reflective interface or element 690 corresponds to a single pixel. As a consequence, and more generally, each reflective interface or element is potentially electrically isolated from each other, and electrically isolated from the various first, second and third conductive layers 610, 620, 645. The apparatus 600 includes many of the layers previously discussed, namely, the substrate layer 605, the first conductive layer 610, the dielectric layers 625 and 640, the emissive layer 615, the second conductive layer 620, the third conductive layer 645, the color layer 630, and coating layer 635, which may be formed of the same materials, may have the same configuration as, and may otherwise be identical to their respective counterparts (substrates 105, 205, 305, 505, dielectric layers 125, 140, 225, 240, 325, 340, 525, 540, emissive layers 115, 215, 315, 515, color layer 130, 230, 330, 530, and coating layer 135, 235, 335, 535) previously discussed. In addition, the first conductive layer 610, the second conductive layer 620, and the third conductive layer 645, may be formed of the same materials previously discussed for their respective counterparts (first conductive layer 110, 210, 310A, 310B, 510, the second conductive layer 120, 220, 320, 420, 520, and the third conductive layer 145, 245, 345, 445, 545).

The plurality of reflective elements or interfaces 690 may be formed by an additional, fourth metal layer, using a highly reflective ink or other highly reflective material. For example, in selected embodiments, an ink having silver flakes (i.e., a flake ink) was utilized to fabricate the apparatus 600 and provide the reflective surfaces or elements 690. In other embodiments, the plurality of reflective elements or interfaces 690 may be fabricated using any material having a suitable refractive index to provide for significant reflection at the interface between the plurality of reflective elements or interfaces 690 and the emissive layer 615.

The plurality of reflective elements 690 provides two novel features of the present invention. First, when a pixel is in an on state and emitting light, the corresponding reflective interface 690 significantly increases the light output from the apparatus 600, acting like a mirror, and enhancing the brightness of the display. Second, when a pixel is in an off state and not emitting light, the corresponding reflective interface 690 provides a darkened area, providing for increased contrast. Notably, the addition of the reflective interfaces 690 does not impair the functioning of the other layers; for example, the reflective interfaces 690 do not interfere with charge accumulation at the lower boundary of the emissive layer 620 with the dielectric layer 625.

FIG. 16 (or FIG. 16) is a block diagram of an exemplary system embodiment 700 in accordance with the teachings of the present invention. The system 700 includes an emissive display 705, which may be any of the various exemplary emissive display embodiments (100, 200, 300, 400, 500) of the present invention. The various first and second conductive layers are coupled through lines or connectors 710 (which may be in the form of a bus) to control bus 715, for coupling to control logic block 720, and for coupling to a power supply 750, which may be a DC power supply or an AC power supply (such as household or building power). The control logic includes a processor 725, a memory 730, and an input/output (I/O) interface 735.

The memory 730 may be embodied in any number of forms, including within any data storage medium, memory device or other storage device, such as a magnetic hard drive, an optical drive, other machine-readable storage or memory media such as a floppy disk, a CDROM, a CD-RW, a memory integrated circuit (“IC”), or memory portion of an integrated circuit (such as the resident memory within a processor IC), including without limitation RAM, FLASH, DRAM, SRAM, MRAM, FeRAM, ROM, EPROM or E²PROM, or any other type of memory, storage medium, or data storage apparatus or circuit, which is known or which becomes known, depending upon the selected embodiment.

The I/O interface 735 may be implemented as known or may become known in the art, and may include impedance matching capability, voltage translation for a low voltage processor to interface with a higher voltage control bus 715, and various switching mechanisms (e.g., transistors) to turn various lines or connectors 710 on or off in response to signaling from the processor 725. The system 700 further comprises one or more processors, such as processor 725. As the term processor is used herein, these implementations may include use of a single integrated circuit (“IC”), or may include use of a plurality of integrated circuits or other components connected, arranged or grouped together, such as microprocessors, digital signal processors (“DSPs”), custom ICs, application specific integrated circuits (“ASICs”), field programmable gate arrays (“FPGAs”), adaptive computing ICs, associated memory (such as RAM and ROM), and other ICs and components. As a consequence, as used herein, the term processor should be understood to equivalently mean and include a single IC, or arrangement of custom ICs, ASICs, processors, microprocessors, controllers, FPGAs, adaptive computing ICs, or some other grouping of integrated circuits which perform the functions discussed below, with associated memory, such as microprocessor memory or additional RAM, DRAM, SRAM, MRAM, ROM, EPROM or E²PROM. A processor (such as processor 725), with its associated memory, may be configured (via programming, FPGA interconnection, or hard-wiring) to control the energizing of (applied voltages to) the first conductive layers, second conductive layers, and third conductive layers of the exemplary embodiments, for corresponding control over what information is being displayed. For example, static or time-varying display information may be programmed and stored, configured and/or hard-wired, in a processor with its associated memory (and/or memory 730) and other equivalent components, as a set of program instructions (or equivalent configuration or other program) for subsequent execution when the processor is operative (i.e., powered on and functioning).

In addition to the control logic 720 illustrated in FIG. 16, those of skill in the art will recognize that there are innumerable equivalent configurations, layouts, kinds and types of control circuitry known in the art, which are within the scope of the present invention.

FIG. 17 (or FIG. 17) is a flow chart of an exemplary method embodiment for fabrication of a printable emissive display in accordance with the teachings of the present invention. Various examples and illustrated variations are also described below. Beginning with start step 800, a substrate is selected, such as coated fiber paper, plastic, etc. Next, in step 805, a first conductive layer is printed, in a first selected pattern, on the substrate. Various patterns have been described above, such as parallel electrodes, groups of electrodes, electrodes with vias, and so on. The step 805 of printing the first conductive layer generally consists further of printing one or more of the following compounds on the substrate: a silver conductive ink, a copper conductive ink, a gold conductive ink, an aluminum conductive ink, a tin conductive ink, a carbon conductive ink, and so on. As illustrated in the examples, this step 805 may also be repeated to increase conductive volume. Next, in step 810, a first dielectric layer is printed or coated over the first conductive layer, followed by printing or coating an emissive layer over the first dielectric layer in step 815 (which also may include printing of reflective interfaces), which is further followed by printing a second dielectric layer over the emissive layer in step 820. These various layers may also be built up through multiple applications (e.g., printing cycles). The first and second dielectric layers are typically comprised of one or more of the dielectric compounds previously discussed, such as barium titanate, titanium dioxide, or other similar mixtures or compounds. The emissive layer typically comprises any of the emissive compounds described above.

Depending upon the various patterns selected, second and third conductive layers may or may not be necessary. When a second conductive layer is necessary or desirable in step 825, the method proceeds to step 830, and a second conductive layer is printed, in a second selected pattern, over the second dielectric layer. Such a second conductive layer typically comprises ATO, ITO, or another suitable compound or mixture. When a second conductive layer is not necessary or desirable in step 825, the method proceeds to step 845. When a third conductive layer is necessary or desirable in step 835, the method proceeds to step 840, and a third conductive layer is printed, in a third selected pattern, over the second conductive layer. This step of printing the third conductive layer typically comprises printing a conductive ink in the third selected pattern having at least two redundant conductive paths. When a third conductive layer is not necessary or desirable in step 835, the method proceeds to step 845.

Depending upon the type of emissive display, a color layer may or may not be necessary following steps 825, 835 or 840. When a color layer is necessary or desirable in step 845, the method proceeds to step 850, and a color layer is printed over the second conductive layer or the third conductive layer, with the color layer comprising a plurality of red, green and blue pixels or subpixels. When a color layer is not necessary or desirable in step 845, the method proceeds to step 855. Following step 850 or 845, the method determines whether a masking layer is necessary or desirable, such as for a back-lit display, step 855, and if so, a masking layer is printed in a fourth selected pattern over the color layer, with the masking layer comprising a plurality of opaque areas adapted to mask selected pixels or subpixels of the plurality of red, green and blue pixels or subpixels, step 860. When a masking layer is not necessary or desirable in step 855, and also following step 860, the method proceeds to step 865, and prints a brightening layer (such as calcium carbonate) and/or a protective or sealing layer over the preceding layers, and the method may end, return step 870.

This methodology described above may be illustrated by the following two examples consistent with the present invention. As mentioned above, it is to be understood that the invention is not limited in its application to the details of construction and to the arrangements of components described below in the examples.

In the following examples, as each layer is applied, that layer is generally given sufficient time to dry or cure, depending both upon temperature, ambient (relative) humidity, and volatility of any selected solvent. For example, the various layers may be dried ambiently (approximately 72 degrees Fahrenheit (F), at 40-50% relative humidity. Various display examples (Example 2, below) have been dried at 150 degrees F., with approximately or substantially 4 hours of drying time for the dielectric layers, and approximately or substantially 1 hour of drying time for the other layers. The various signage examples (Example 1) may be dried at approximately or substantially at higher temperatures (e.g., 220 degrees F.) for a considerably shorter duration (e.g., 30 seconds). It will be understood, therefore, that a wide variety of suitable drying temperatures and durations may be determined empirically by those of skill in the art, and all such variations are within the scope of the present invention.

Two other techniques have also been incorporated into the following examples. As mentioned above, proper alignment (registration) between layers, depending upon the selected embodiment, may be important. As a consequence, when multiple layers of conductive material (ink) are applied in order to increase the conductive volume, each subsequent layer is made slightly smaller (choked) than the immediately preceding conductive layer to reduce the probability of registration error (in which a conductive material would be printed beyond the bounds of the original conductive trace).

Second, as drying may cause shrinkage, the substrate and any additional or intervening layers may be remoisturized, allowing the substrate and any additional layers to re-swell to substantially its or their original size before applying the next layer. In the examples discussed below, such remoisturizing is employed during the applications of the conductive layers, to avoid any subsequent swelling of the materials after the conductive inks have set (which could potentially result in an open circuit).

### EXAMPLE 1

### Signage

Using either continuous roll or sheeted substrate, a surface finish coating is applied, in order to smooth the surface of the substrate (on a micro or detailed level). A conductive ink is patterned on the “live” area of the substrate (i.e., the area to be illuminated) by offset printing, and allowed to dry as discussed above. Multiple applications of conductive ink are applied, using the alignment (reduced or choked patterning), and the remoisturizing discussed above. One or more dielectric layers are applied as a patterned coating on the area to be illuminated, and allowed to dry as discussed above. A polymer reflective (or mirror) layer is applied and cured through ultraviolet exposure, providing the plurality of reflective elements or interfaces. An emissive phosphor is applied as one or more patterned coatings on the area to be illuminated, and allowed to dry as discussed above. A clear ATO coating is applied as a patterned coating on the area to be illuminated, and allowed to dry or cure as discussed above, e.g., by brief, mild heating. Fluorescent RGB or specialty colors are then applied to the appropriate areas to be illuminated, and allowed to dry as discussed above. CMYK colorants are printed via a halftone process or as spot colors to form the remaining (non-illuminated) are of the sign. A polymer sealant is applied via coating and cured via ultraviolet exposure.

### EXAMPLE 2

### Display

Also using either continuous roll or sheeted substrate, a surface finish coating is applied, in order to smooth the surface of the substrate (on a micro or detailed level). A conductive ink is patterned as rows (or columns) on this substrate surface using flexographic printing, and allowed to dry as discussed above. Multiple applications of conductive ink are applied, using the alignment (reduced or choked patterning), and the remoisturizing discussed above. One or more dielectric layers are applied as a coating bounded by the area of the active display, and allowed to dry as discussed above. A polymer reflective (or mirror) layer is applied and cured through ultraviolet exposure, providing the plurality of reflective elements or interfaces. An emissive phosphor is applied as one or more coatings bounded by (and slightly smaller than) the area of the active display of the dielectric layer (i.e., choked or slightly reduced area to be within the boundaries of the dielectric layer), and allowed to dry as discussed above. A conductive ink is patterned as columns (or rows) on this substrate surface using flexographic printing, and allowed to dry as discussed above. Following remoisturizing, each conductive ink trace is patterned with multiple apertures or bends, such as those described above with respect to FIG. 10, to substantially allow maximum or sufficient edge length. A clear ATO conductor is applied through flexographic printing, patterned as columns (or rows) over the top conductive ink trace and also choked to be within each column (or row), and allowed to dry or cure as discussed above, e.g., by brief, mild heating. Fluorescent RGB colors are then applied at each intersection of a top and bottom conductive ink (pixel or subpixel) as color triads, and allowed to dry as discussed above. A polymer sealant is applied via coating and cured via ultraviolet exposure.

Numerous advantages of the present invention are readily apparent. As a light emitting display, the various embodiments of the invention may be fabricated using any of a plurality of conventional and comparatively inexpensive printing or coating processes, rather than through the highly involved and expensive semiconductor fabrication techniques, such as those utilized to make LCD displays, plasma displays, or ACTFEL displays. The various embodiments of the invention may be embodied using comparatively inexpensive materials, such as paper and phosphors, substantially reducing production costs and expenses.

The various embodiments have a flat form factor and are scalable, virtually limitlessly, and are highly robust. For example, the various embodiments may be scaled up to have a form factor of wallpaper, billboard or larger size, or down to cellular telephone or wristwatch display size. The various embodiments also provide a wide range of selectable resolutions.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

1. An emissive display comprising:
a substrate;
a first plurality of conductors coupled to the substrate;
a first dielectric layer coupled to the first plurality of conductors;
an emissive layer coupled to the first dielectric layer; and
a second plurality of conductors coupled to the emissive layer, wherein the second plurality of conductors are, at least partially, adapted to transmit visible light.

2. The emissive display of claim 1, wherein the emissive display is adapted to emit visible light from the emissive layer through the second plurality of conductors when a first conductor of the first plurality of conductors and a second conductor of the second plurality of conductors are energized.

3. The emissive display of claim 1, wherein the first plurality of conductors are substantially parallel in a first direction, and the second plurality of conductors are substantially parallel in a second direction, the second direction different than the first direction.

4. The emissive display of claim 1, wherein the first plurality of conductors and the second plurality of conductors are disposed to each other in substantially perpendicular directions, and wherein a region substantially between a first conductor of the first plurality of conductors and a second conductor of the second plurality of conductors defines a picture element (pixel) or subpixel of the emissive display.

5. The emissive display of claim 4, wherein the pixel or subpixel of the emissive display is selectively addressable by selecting the first conductor of the first plurality of conductors and selecting the second conductor of the second plurality of conductors.

6. The emissive display of claim 5, wherein the selection is an application of a voltage, and wherein the addressed pixel or subpixel of the emissive display emits light upon application of the voltage.

7. The emissive display of claim 1, further comprising:
a third plurality of conductors coupled correspondingly to the second plurality of conductors, the third plurality of conductors having an impedance comparatively lower than the second plurality of conductors.

8. The emissive display of claim 7, wherein each conductor of the third plurality of conductors comprises at least two redundant conductive paths and is formed from a conductive ink.

9. The emissive display of claim 1, further comprising:
a color layer coupled to the second conductive layer, the color layer having a plurality of red, green and blue pixels or subpixels.

10. The emissive display of claim 9, further comprising:
a masking layer coupled to the color layer, the masking layer comprising a plurality of opaque areas adapted to mask selected pixels or subpixels of the plurality of red, green and blue pixels or subpixels.

11. The emissive display of claim 1, wherein the first plurality of conductors is formed by printing on the substrate, the first dielectric layer is formed by printing on the first plurality of conductors, the emissive layer is formed by printing over the first dielectric layer, and the second plurality of conductors is formed by printing over the emissive layer and any intervening layers.

12. The emissive display of claim 1, wherein the substrate is one or more of the following: paper, coated paper, plastic coated paper, fiber paper, cardboard, poster paper, poster board, books, magazines, newspapers, wooden boards, plywood, paper or wood-based products in any selected form; plastic materials in any selected form; natural and synthetic rubber materials and products in any selected form; natural and synthetic fabrics in any selected form; glass, ceramic, and other silicon or silica-derived materials and products, in any selected form; concrete (cured), stone, and other building materials and products; any insulator; any semiconductor.

13. The emissive display of claim 1, wherein the emissive layer further comprises a second dielectric layer coupled to the second plurality of conductors.

14. (canceled)

15. The emissive display of claim 1, wherein the first plurality of conductors is formed from a conductive ink printed on the substrate.

16. (canceled)

17. The emissive display of claim 1, wherein the first plurality of conductors is formed from one or more of the following compounds printed or coated on the substrate: a silver conductive ink, a copper conductive ink, a gold conductive ink, an aluminum conductive ink, a tin conductive ink, or a carbon conductive ink.

18. (canceled)

19. The emissive display of claim 1, wherein the emissive layer comprises a phosphor.

20. The emissive display of claim 1, wherein the second plurality of conductors comprises antimony tin oxide or indium tin oxide.

21. (canceled)

22. The emissive display of claim 1, wherein the emissive display is substantially flat and has a depth less than two millimeters.

23. The emissive display of claim 1, wherein the emissive display has a substantially flat form and a depth less than one-half centimeter.

24. The emissive display of claim 1, wherein the emissive display has width and length providing a display area greater than one meter squared and a depth less than three millimeters.

25. An emissive display comprising:
a substrate;
a first conductive layer coupled to the substrate;
a first dielectric layer coupled to the first conductive layer;
an emissive layer coupled to the first dielectric layer;
a second dielectric layer coupled to the emissive layer;
a second, transmissive conductive layer coupled to the second dielectric layer; and
a third conductive layer coupled to the second transmissive conductive layer, the third conductive layer having a comparatively lower impedance than the second transmissive conductive layer.

26. The emissive display of claim 25, wherein each layer is formed by printing.

27. The emissive display of claim 25, wherein the third conductive layer is formed from a conductive ink and comprises at least two redundant conductive paths.

28. The emissive display of claim 26, wherein the first conductive layer comprises a first plurality of conductors disposed substantially in parallel in a first direction, and wherein the second transmissive conductive layer and the third conductive layer comprise a second plurality of conductors disposed substantially in parallel in a second direction, the second direction different than the first direction.

29. The emissive display of claim 26, wherein the first conductive layer comprises a first plurality of conductors, and wherein the second transmissive conductive layer and the third conductive layer comprise a second plurality of conductors, wherein the first plurality of conductors and the second plurality of conductors are disposed to each other in substantially perpendicular directions, and wherein a region substantially between a first conductor of the first plurality of conductors and a second conductor of the second plurality of conductors defines a picture element (pixel) or subpixel of the emissive display.

30. The emissive display of claim 29, wherein each conductor of the second plurality of conductors formed from the third conductive layer comprises at least two redundant conductive paths and is formed from a conductive ink.

31. The emissive display of claim 29, wherein the pixel or subpixel of the emissive display is selectively addressable by selecting the first conductor of the first plurality of conductors and selecting the second conductor of the second plurality of conductors.

32. The emissive display of claim 31, wherein the selection is an application of a voltage, and wherein the addressed pixel or subpixel of the emissive display emits light upon application of the voltage.

33. The emissive display of claim 25, wherein the substrate is one or more of the following: paper, coated paper, plastic coated paper, fiber paper, cardboard, poster paper, poster board, books, magazines, newspapers, wooden boards, plywood, paper or wood-based products in any selected form; plastic materials in any selected form; natural and synthetic rubber materials and products in any selected form; natural and synthetic fabrics in any selected form; glass, ceramic, and other silicon or silica-derived materials and products, in any selected form; concrete (cured), stone, and other building materials and products; any insulator; any semiconductor.

34. The emissive display of claim 25, wherein the emissive display is adapted to emit visible light from the emissive layer through the second, transmissive conductive layer when the first conductive layer and either the second, transmissive conductive layer or third conductive layer are energized.

35. The emissive display of claim 25, further comprising:
a color layer coupled to the second, transmissive conductive layer and the third conductive layer, the color layer comprising a plurality of red, green and blue pixels or subpixels; and
a sealing layer.

36. The emissive display of claim 35, wherein the plurality of layers further comprises:
a masking layer between the color layer and the sealing layer, the masking layer comprising a plurality of opaque areas adapted to mask selected pixels or subpixels of the plurality of red, green and blue pixels or subpixels.

37. (canceled)

38. The emissive display of claim 25, wherein the first conductive layer is formed from a conductive ink.

39. The emissive display of claim 25, wherein the first conductive layer is formed from one or more of the following compounds printed or coated on the substrate: a silver conductive ink, a copper conductive ink, a gold conductive ink, an aluminum conductive ink, a tin conductive ink, or a carbon conductive ink.

40. (canceled)

41. The emissive display of claim 25, wherein the emissive layer comprises a phosphor.

42. The emissive display of claim 25, wherein the second conductive layer comprises antimony tin oxide or indium tin oxide.

43. (canceled)

44. The emissive display of claim 25, wherein the first conductive layer comprises a first plurality of conductors and a second plurality of conductors, wherein the second plurality of electrodes are electrically insulated from the first plurality of electrodes, and wherein the second plurality of electrodes are electrically coupled to the second conductive layer.

45. The emissive display of claim 44, wherein the emissive display is adapted to emit visible light from the emissive layer when the first plurality of electrodes and second plurality of electrodes are energized.

46. The emissive display of claim 25, wherein the emissive display is substantially flat and has a depth less than two millimeters.

47. The emissive display of claim 25, wherein the emissive display has a substantially flat form factor and a depth less than one-half centimeter.

48. The emissive display of claim 25 wherein the emissive display has width and length providing a display area greater than one meter squared and a depth less than three millimeters.

49. An emissive display comprising:
a substrate;
a first conductive layer coupled to the substrate, the first conductive layer comprising a first plurality of electrodes and a second plurality of electrodes, the second plurality of electrodes electrically insulated from the first plurality of electrodes;
a first dielectric layer coupled to the first conductive layer;
an emissive layer coupled to the first dielectric layer;
a second dielectric layer coupled to the emissive layer; and
a second, transmissive conductive layer coupled to the second dielectric layer.

50. The emissive display of claim 49, wherein the second transmissive conductive layer is further coupled to the second plurality of electrodes.

51. The emissive display of claim 50, wherein the coupling is an electrical via connection.

52. The emissive display of claim 50, wherein the coupling is by abutment.

53. The emissive display of claim 49, wherein the emissive display is adapted to emit visible light from the emissive layer when the first plurality of electrodes, second plurality of electrodes, and the second, transmissive conductive layer are energized.

54. The emissive display of claim 49, wherein each layer is formed by printing.

55. The emissive display of claim 49, wherein the substrate is one or more of the following: paper, coated paper, plastic coated paper, fiber paper, cardboard, poster paper, poster board, books, magazines, newspapers, wooden boards, plywood, paper or wood-based products in any selected form; plastic materials in any selected form; natural and synthetic rubber materials and products in any selected form; natural and synthetic fabrics in any selected form; glass, ceramic, and other silicon or silica-derived materials and products, in any selected form; concrete (cured), stone, and other building materials and products; any insulator; any semiconductor.

56. (canceled)

57. The emissive display of claim 49, wherein the first conductive layer is formed from one or more of the following compounds printed or coated on the substrate: a silver conductive ink, a copper conductive ink, a gold conductive ink, an aluminum conductive ink, a tin conductive ink, or a carbon conductive ink.

58. The emissive display of claim 49, wherein the emissive layer comprises a phosphor.

59. The emissive display of claim 49, further comprising:
a color layer coupled to the second transmissive conductive layer, the color layer having a plurality of red, green and blue pixels or subpixels.

60. The emissive display of claim 59, further comprising:
a masking layer coupled to the color layer, the masking layer comprising a plurality of opaque areas adapted to mask selected pixels or subpixels of the plurality of red, green and blue pixels or subpixels.

61. (canceled)

62. The emissive display of claim 49, wherein the emissive display has a substantially flat form factor and a depth less than two millimeters.

63. An emissive display comprising:
a substrate;
a first plurality of conductors coupled to the substrate;
a first dielectric layer coupled to the first plurality of conductors, the first dielectric layer having a plurality of reflective interfaces;
an emissive layer coupled to the first dielectric layer and the plurality of reflective interfaces; and
a second plurality of conductors coupled to the emissive layer, wherein the second plurality of conductors are, at least partially, adapted to transmit visible light.

64. The emissive display of claim 63, wherein the plurality of reflective interfaces are metal.

65. The emissive display of claim 63, wherein the plurality of reflective interfaces are metal flakes.

66. The emissive display of claim 63, wherein the plurality of reflective interfaces are formed by printing a metal flake ink.

67. The emissive display of claim 63, wherein the plurality of reflective interfaces have a refractive index different from refractive indices of the first dielectric layer and the emissive layer.

68. The emissive display of claim 63, wherein the emissive display is adapted to emit visible light from the emissive layer through the second plurality of conductors when a first conductor of the first plurality of conductors and a second conductor of the second plurality of conductors are energized.

69. The emissive display of claim 63, wherein the first plurality of conductors are substantially parallel in a first direction, and the second plurality of conductors are substantially parallel in a second direction, the second direction different than the first direction.

70. The emissive display of claim 63, wherein the first plurality of conductors and the second plurality of conductors are disposed to each other in substantially perpendicular directions, and wherein a region substantially between a first conductor of the first plurality of conductors and a second conductor of the second plurality of conductors defines a picture element (pixel) or subpixel of the emissive display.

71. The emissive display of claim 70, wherein at least one reflective interface of the plurality of reflective interfaces is within a pixel.

72. The emissive display of claim 70, wherein the pixel or subpixel of the emissive display is selectively addressable by selecting the first conductor of the first plurality of conductors and selecting the second conductor of the second plurality of conductors.

73. The emissive display of claim 72, wherein the selection is an application of a voltage, and wherein the addressed pixel or subpixel of the emissive display emits light upon application of the voltage.

74. The emissive display of claim 63, further comprising:
a third plurality of conductors coupled correspondingly to the second plurality of conductors, the third plurality of conductors having an impedance comparatively lower than the second plurality of conductors.

75. The emissive display of claim 74, wherein each conductor of the third plurality of conductors comprises at least two redundant conductive paths and is formed from a conductive ink.

76. The emissive display of claim 63, further comprising:
a color layer coupled to the second conductive layer, the color layer having a plurality of red, green and blue pixels or subpixels.

77. The emissive display of claim 76, further comprising:
a masking layer coupled to the color layer, the masking layer comprising a plurality of opaque areas adapted to mask selected pixels or subpixels of the plurality of red, green and blue pixels or subpixels.

78. The emissive display of claim 63, wherein the first plurality of conductors is formed by printing on the substrate, the first dielectric layer is formed by printing on the first plurality of conductors, the plurality of reflective interfaces is formed by printing on the first dielectric layer, the emissive layer is formed by printing over the first dielectric layer and the plurality of reflective interfaces, and the second plurality of conductors is formed by printing over the emissive layer and any intervening layers.

79. The emissive display of claim 63, wherein the substrate is one or more of the following: paper, coated paper, plastic coated paper, fiber paper, cardboard, poster paper, poster board, books, magazines, newspapers, wooden boards, plywood, paper or wood-based products in any selected form; plastic materials in any selected form; natural and synthetic rubber materials and products in any selected form; natural and synthetic fabrics in any selected form; glass, ceramic, and other silicon or silica-derived materials and products, in any selected form; concrete (cured), stone, and other building materials and products; any insulator; any semiconductor.

80. The emissive display of claim 63, wherein the emissive layer further comprises a second dielectric layer coupled to the second plurality of conductors.

81. The emissive display of claim 63, wherein the emissive display is substantially flat and has a depth less than two millimeters.

82. A method of fabricating an emissive display, the method comprising:
using a conductive ink, printing a first conductive layer, in a first selected pattern, on a substrate;
printing a first dielectric layer over the first conductive layer;
printing an emissive layer over the first dielectric layer;
printing a second dielectric layer over the emissive layer;
printing a second, transmissive conductive layer, in a second selected pattern, over the second dielectric layer; and
using a conductive ink, printing a third conductive layer over the second transmissive conductive layer, wherein the third conductive layer has a comparatively lower impedance than the second transmissive conductive layer.

83. The method of claim 82, wherein the substrate is one or more of the following: paper, coated paper, plastic coated paper, fiber paper, cardboard, poster paper, poster board, books, magazines, newspapers, wooden boards, plywood, paper or wood-based products in any selected form; plastic materials in any selected form; natural and synthetic rubber materials and products in any selected form; natural and synthetic fabrics in any selected form; glass, ceramic, and other silicon or silica-derived materials and products, in any selected form; concrete (cured), stone, and other building materials and products; any insulator; any semiconductor.

84. The method of claim 82, wherein the steps of printing the first conductive layer and the third conductive layer further comprises printing one or more of the following compounds on the substrate: a silver conductive ink, a copper conductive ink, a gold conductive ink, an aluminum conductive ink, a tin conductive ink, or a carbon conductive ink.

85. The method of claim 82, wherein the step of printing the third conductive layer further comprises printing a conductive ink in a third selected pattern having at least two redundant conductive paths.

86. The method of claim 82, wherein the step of printing the first dielectric layer further comprises printing a plurality of reflective interfaces.

87. The method of claim 86, wherein the step of printing the plurality of reflective interfaces further comprises printing a plurality of defined pixel regions with a metal flake ink.

88. The method of claim 82, further comprising:
printing a color layer over the second dielectric layer, a second conductive layer or a third conductive layer, the color layer comprising a plurality of red, green and blue pixels or subpixels.

89. The method of claim 88, further comprising:
printing a masking layer in a fourth selected pattern over the color layer, the masking layer comprising a plurality of opaque areas adapted to mask selected pixels or subpixels of the plurality of red, green and blue pixels or subpixels.

90. The method of claim 82, wherein the first selected pattern defines a first plurality of conductors disposed in a first direction, wherein the second selected pattern defines a second plurality of conductors disposed in a second direction, the second direction different from the first direction.

91. The method of claim 82, wherein the step of printing the first conductive layer further comprises printing a first plurality of conductors, wherein the step of printing the second conductive layer further comprises printing a second plurality of conductors disposed to the first plurality of conductors in a substantially perpendicular direction to create a region substantially between a first conductor of the first plurality of conductors and a second conductor of the second plurality of conductors which defines a picture element (pixel) or subpixel of the emissive display.
